(19) United States
(12) Patent Application Publication
(10) Pub. No.: US 2025/0039637 A1
(43) Pub. Date: Jan. 30, 2025

(54) DYNAMIC SELECTION OF LOCATION DATA FROM MULTIPLE SOURCES FOR USER DEVICE LOCATION DETECTION FOR LOCATION-BASED SERVICES USING MIX AND MATCH SOURCES

(71) Applicant: DISH Wireless L.L.C., Englewood, CO (US)

(72) Inventors: William C. Beckwith, Washington, DC (US); Mehdi Alasti, Arlington, VA (US); Adam Bensaid, Parker, CO (US); Raghavendhra Rao, Littleton, CO (US)

(21) Appl. No.: 18/610,066

(22) Filed: Mar. 19, 2024

Related U.S. Application Data
(60) Provisional application No. 63/515,527, filed on Jul. 25, 2023.

(51) Int. Cl. H04W 4/02; H04W 4/029

(52) U.S. Cl. CPC H04W 4/025; H04W 4/029

(57) ABSTRACT

System and method for selecting location data to be used as the location of a user device using a location-based service. Horizontal location data and vertical location data for the user device are obtained from multiple sources. A horizontal location uncertainty and a vertical location uncertainty are determined or obtained for each source. In response to determining that both the horizontal location uncertainty meets a threshold horizontal uncertainty value and the vertical location uncertainty meets a threshold vertical uncertainty value, the corresponding source is identified as compliant. In response to identifying no compliant sources, a lowest horizontal location uncertainty and a lowest vertical location uncertainty are selected from among the plurality of sources.

### BACKGROUND

Mobile phones are being used more and more by more and more people. As the use of mobile phones has increased, so too has the need to make 911 calls from mobile phones. The speed at which emergency services can respond to a 911 call relies on identifying the caller's location. Unfortunately, many callers are unable to provide their location. As a result, the Federal Communications Commission has required cellular service providers to obtain and provide the mobile phone's location to the emergency services within a certain level of accuracy. Similarly, many mobile phones have other applications or other services that rely on or use location information. But mobile phones can be unreliable in providing or obtaining accurate location information. It is with respect to these and other considerations that the embodiments described herein have been made.

### BRIEF SUMMARY

Embodiments are directed towards systems and methods selecting location data from a plurality of sources to be used as the location of a user device using a location-based service, such as making an emergency call to 911, which is the universal phone number in the United States for reporting emergencies and requesting first-responder assistance. Horizontal location data and vertical location data for the user device are obtained from each of the plurality of sources. A horizontal location uncertainty of the horizontal location data is determined for each corresponding source, and a vertical location uncertainty of the vertical location data is determined for each corresponding source. The horizontal location uncertainty and the vertical location uncertainty are then compared to a threshold horizontal location and a threshold vertical location, respectively, to determine if a source is compliant with various accuracy compliance requirements. If there is at least one compliant source, an optimum compliant source is selected therefrom, such that the horizontal location data and the vertical location data of the optimum compliant source is selected as the location of the user device for the location-based service, e.g., during the 911 call.

In some embodiments, if there are no compliant sources, then an alternative threshold horizontal location or an alternative threshold vertical location are selected. The horizontal location uncertainty and the vertical location uncertainty are then compared to the alternative threshold horizontal location or the alternative threshold vertical location, respectively, to determine if a source is compliant. In other embodiments, if there are no compliant sources, then an optimum non-compliant source may be selected. In yet other embodiments, if there are no compliant sources, a mix and match of a lowest horizontal location uncertainty and a lowest vertical location uncertainty may be selected from among the plurality of sources for the horizontal location data and the vertical location data as the location of the user device for the location-based service.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment 100 for providing user device location data accuracy compliance for 911 calls in accordance with embodiments described herein;

FIG. 2 is a context diagram of a non-limiting embodiment of systems that provide functionality to dynamically obtain and select location source data for 911 calls in accordance with embodiments described herein;

FIGS. 3A-3F illustrate a logical flow diagram showing one embodiment of a process for dynamically obtaining and selecting location source data for 911 calls in accordance with embodiments described herein;

FIG. 4 shows a use case visualization of location accuracy compliance requirements in accordance with embodiments described herein;

FIGS. 5A-5B show use case visualizations of location uncertainty in accordance with embodiments described herein;

FIG. 6 shows a use case visualization of alternate location accuracy compliance requirements in accordance with embodiments described herein;

FIGS. 7A-7E illustrate a logical flow diagram showing another embodiment of a process for dynamically obtaining and selecting location source data for location-based services in accordance with embodiments described herein; and

FIG. 8 shows a system diagram that describe various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

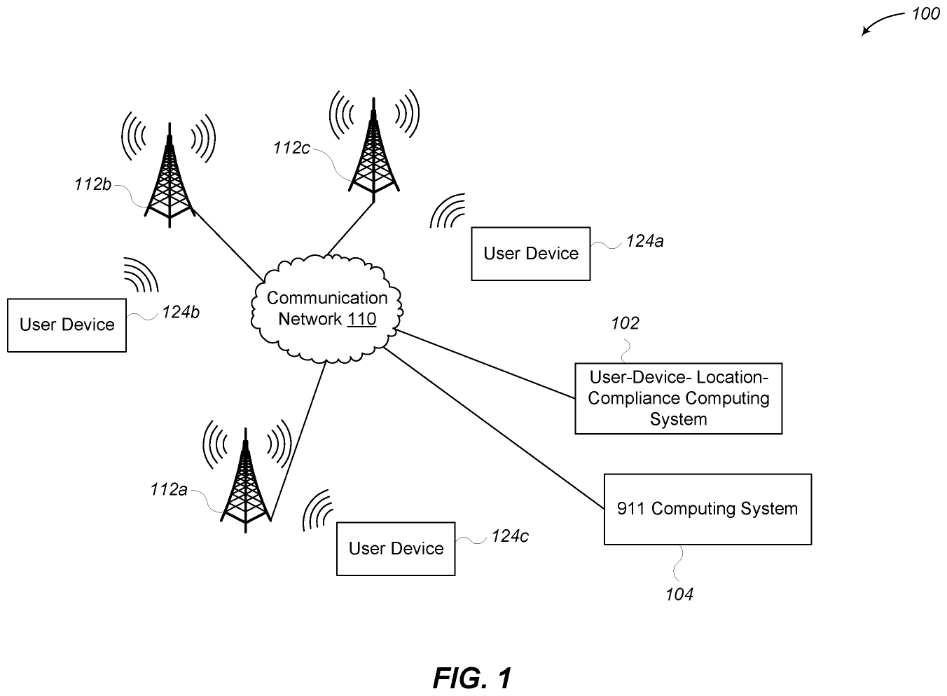

FIG. 1 illustrates a context diagram of an environment 100 for providing user device location data accuracy compliance for 911 calls in accordance with embodiments described herein. Environment 100 includes a plurality of cells 112a-112c, a plurality of user devices 124a-124c, a mobile-device-location-compliance computing system 102, a 911 computing system 104, and a communication network 110.

The cells 112a-112c are cellular towers that together provide the hardware infrastructure of a cellular communications network, e.g., a 5G cellular communications network. The cells 112a-112c may include or be in communication with base stations, radio back haul equipment, antennas, or other devices, which are not illustrated for ease of discussion. In various embodiments, the cells 112a-112c may communicate with each other via communication network 110. Communication network 110 includes one or more wired or wireless networks, which may include a series of smaller or private connected networks that carry information between the cells 112a-112c.

The user devices 124a-124c are computing devices that utilize at least one location-based service. User devices 124a-124c may be referred to as user devices, mobile devices, mobile computing devices, user mobile devices, user equipment, or some combination thereof, or other similar terminology. Examples of user devices 124a-124c may include, but are not limited to, mobile phones, smartphones, tablets, cellular-enabled laptop computers, RedCap devices, Internet-of-Things devices, or other computing devices that can utilize a location-based service. As one illustrative example, user devices 124a-124c may be mobile devices that are configured to receive and transmit cellular communications with the cells 112a-112c. The user devices 124a-124c may be configured to transmit emergency calls to a 911 dispatcher (not illustrated) via the 911 computing system 104 of the cellular communications network. Emergency calls, also referred to as 911 calls or e911 calls, are phone calls or messages, or other emergency communications, made from user devices 124 to a 911 dispatcher via the 911 computing system 104 of the cellular communication network.

The 911 computing system 104 is a computing device or cloud computing environment within the cellular communications network that manages or coordinates 911 calls between user devices 124 and a 911 dispatcher (also referred to as a Public Safety Answering Point or PSAP). In some embodiments, the 911 computing system 104 operates as an intermediate for 911 calls between the user devices 124a-124c and the 911 dispatcher. In other embodiments, the 911 computing system 104 initially receives the 911 call, but transfers or hands off the 911 call to the 911 dispatcher, such that the 911 computing system 104 is not an intermediary during the remainder of the 911 call. In yet other embodiments, the 911 computing system 104 may transfer or hand off the 911 call to another 911 data-management computing system (not illustrated) to manage the 911 call between the user device 124 and the 911 dispatcher.

When a 911 call is made by a user device 124, the 911 computing system 104 receives the call and notifies the dispatcher (or PSAP) of the call. The 911 computing system 104 also obtains the location of the user device 124 and provides it to the dispatcher. This location includes horizontal location data (x/y-axis) and vertical location data (z-axis). The dispatcher (or PSAP) generally relies on the accuracy of this location data to quickly dispatch emergency services to the user device's location.

For a cellular communications network, and the 911 computing system 104 of the network, to be certified for handling 911 calls, it generally must comply with certain accuracy requirements when reporting the location of the user device 124 that is making a 911 call. For example, the Federal Communications Commission (FCC) has set certification requirements to verify the accuracy of the user device location data being collected from the user device 124. Currently, the FCC requires a cellular communications network to show that it can provide horizontal location data with an accuracy of 50 meters (i.e., the reported horizontal location data must be within a radius of 50 meters of the actual horizontal location of the user device making the 911 call) and vertical location data with an accuracy of 3.0 (three) meters (i.e., the reported vertical location data must be plus or minus 3.0 meters of the actual vertical location of the user device making the 911 call) for 80% of all wireless 911 calls placed. Although FCC rules are discussed herein, other location accuracy regulatory requirements, rules, or benchmarks may be utilized for different location-based services. Accordingly, some location-based services (or devices) may utilize broader benchmarks, whereas other location-based services (or devices) may utilized more accurate benchmarks.

Unfortunately, there are a number of reasons why it can be very difficult for the cellular communication network to verify the accuracy of 911 calls. For example, user devices can utilize or collect its location data from one or a plurality of sources. But the accuracy of these sources may change due to multiple variables, including, but not limited to, the location of the user device, physical objects obstructing wireless signals, radio frequency interference, technology limitations, or other location-collection inaccuracies. And because FCC rules require cellular communications networks to process 911 calls for all user devices, not just those user devices that have a service plan or are members of the mobile communications network, the cellular communications network cannot guarantee the accuracy of all location data of all 911 calls. In addition, there is no known (“ground-truth”) location data external to a device placing a 911 call, so there is no way to verify the actual location of a 911 call in real time. As a result, the cellular communications networks test location data at known locations for a plurality of simulated 911 calls across various morphologies in order to confirm in a test environment that location data reported by the user device or the cellular communications network are accurate within FCC (or other regulatory authorities) standards when deployed in real-world environments. By utilizing embodiments described herein, the mobile-device-location-compliance computing system 102 analyzes location data from a plurality of sources for 911 calls (whether simulated or actual) to capture sufficient location data for the cellular communications network to meet current accuracy-compliance requirements.

The mobile-device-location-compliance computing system 102 is a server, computing device, cloud computing environment, or some other computing system configured to receive location data from a plurality of sources for a plurality of calls made my user devices 124a-124c and determine if the location sources are compliant with location accuracy requirements. These calls may be actual 911 calls or simulated 911 calls. The mobile-device-location-compliance computing system 102 analyzes the horizontal location data (also referred to as horizontal positioning data) and the vertical location data (also referred to a vertical positioning data) from each source of each call to determine if the location data meets various compliance requirements.

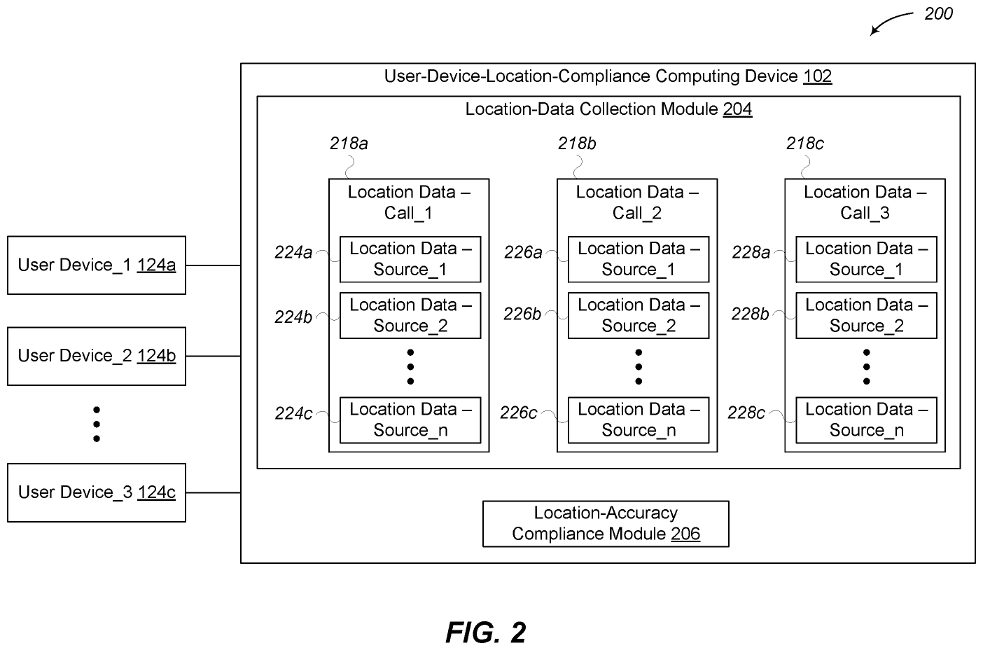

FIG. 2 is a context diagram of a non-limiting embodiment of systems that provide functionality to dynamically obtain and select location source data for 911 calls in accordance with embodiments described herein. Example 200 includes a mobile-device-location-compliance computing device 102 and a plurality of user devices 124a-124c, similar to FIG. 1. The user devices 124a-124c may be separate or distinct user devices making 911 calls from a plurality of known locations, or they may be the same user device making separate 911 calls from the plurality of known locations, or they may be separate or distinct user devices making a plurality of 911 calls from a plurality of known locations.

The mobile-device-location-compliance computing device 102 includes a location-data collection module 204 and a location-accuracy compliance module 206. The location-data collection module 204 generates, determines, collects, or obtains location data 218a-218c from a plurality of location sources associated with a plurality of 911 calls being made by user devices 124a-124c. The location data 218a-218c from one or more sources may include horizontal location data (the horizontal position of the user device on the Earth) or vertical location data (the altitude or elevation of the user device relative to the Earth), or a combination thereof.

The location sources from which location data 218a-218c is determined or obtained may include horizontal location sensors or systems that capture horizontal location data of a user device at the time of a call and vertical location sensors or systems to capture vertical location data of the user device at the time of the call. Examples of horizontal location sensors or systems may include, but are not limited to, Global Navigation Satellite System (GNSS) data (e.g., Global Positioning System (GPS), GLONASS, BeiDou, Galileo, Indian Regional Navigation Satellite System (IRNSS), Quasi-Zenith Satellite System (QZSS), WiFi, Bluetooth Low Energy (BLE), other horizonal positional sensors (e.g., accelerometers or gyroscopes), or the like), cell tower triangulation, cell identification (e.g., a location of the cell tower in which the user device is communicating), enhanced cell identification (e.g., a relative direction or distance from the location of the cell tower in which the user device is communicating and few neighboring cell towers in which the user device can measure their received power), or other systems configured to capture a horizontal location of a user device making a call. Examples of vertical location sensors or systems may include, but are not limited to, Global Positioning System (GPS) data, Global Navigation Satellite System (GNSS) data (e.g., Global Positioning System (GPS), GLONASS, BeiDou, Galileo, Indian Regional Navigation Satellite System (IRNSS), Quasi-Zenith Satellite System (QZSS), WiFi, Bluetooth Low Energy (BLE), other vertical positional sensors (e.g., accelerometers or gyroscopes), barometric positioning sensors, or the like), barometric sensor, enhanced barometric sensor (e.g., biometric sensor data calibrated to the horizontal location of the user device or to the current weather at the horizontal location of the user device), crowdsourced data based on known Wi-Fi hot spots, RF finger-printing, beacons, or other systems configured to capture a vertical location of the user device making the call. Accordingly, the location sources may be some combination of location sources on or employed by the user devices 124a-124c or determined by the mobile-device-location-compliance computing device 102 separate or independent of the user devices, or a hybrid location system that utilizes a combination of information provided by the user devices and generated by the network. Thus, the user devices may generate and provide some location source data and the network (e.g., the mobile-device-location-compliance computing device 102) may generate or determine other location source data (e.g., without the user device providing location data) . . .

Once obtained, the location-data collection module 204 stores the location data 218a-218c of user devices 124a-124c associated with a plurality of 911 calls or simulated 911 calls. In this example, the location-data collection module 204 stores location data 218a of a user device (e.g., user device 124a) for a first call, location data 218b of a user device (e.g., user device 124b) for a second call, and location data 218c of a user device (e.g., user device 124c) for a third call.

The location data 218a for the first call includes location data 224a from a first source, location data 224b from a second source, and location data 224c from a third source. The location data 224a-224c from the separate sources may include horizontal location data, vertical location data, or a combination of both. The location data 218b for the second call includes location data 226a from a first source, location data 226b from a second source, and location data 226c from a third source. The location data 224a-224c from the separate sources may include horizontal location data, vertical location data, or a combination of both. The location data 218c for the third call includes location data 228a from a first source, location data 228b from a second source, and location data 228c from a third source. The location data 224a-224c from the separate sources may include horizontal location data, vertical location data, or a combination of both. Although location data 224a-224c, location data 226a-226c, and location data 228a-228c are from a “first source,” a “second source,” and a “third source,” the “first sources” may be the same source or different sources, the “second sources” may be the same source or different sources, and the “third sources” may be the same source or different sources. Accordingly, the various location data for the separate calls made by the user devices may be from the same, similar, or different sources.

The location-accuracy compliance module 206 is configured to perform embodiments described herein to analyze the location data from a plurality of source to dynamically select location data for a user device making a 911 call, which allows for the location-accuracy compliance module 206 to determine if the location reporting for 911 calls meet location accuracy compliance requirements. In some embodiments, the location-accuracy compliance module 206 may employ one or more decision engines to select the location data for a user device associated with a 911 call. The one or more decision engines can utilized trained artificial intelligence or machine learning models to determine which sources are compliant or non-compliant, to determine an optimal source when there are multiple compliant sources, to determine an optimal source when there are no compliant sources. Such artificial intelligence or machine learning models may be trained using several real-world location sources, along with actual location measurements and their uncertainty values. The training may involve teaching, for example, a neural network how to select location data using embodiments described herein and the location uncertainties from multiple sources. The artificial intelligence or machine learning models may also be trained using past location data (e.g., using simulated or actual horizontal location information and actual vertical location information for previous test calls), historical data, and a map to enhance its decision-making. For example, a map can exclude impossible or improbable locations of making a 911 call. In various embodiments, the decision engines (e.g., the trained artificial intelligence or machine learning models) may be tested to verify that they collectively meet the location accuracy compliance requirements (e.g., as set by the FCC).

In some embodiments, the location-accuracy compliance module 206 can use one or more decision engines (e.g., trained artificial intelligence or machine learning models) for location source selection based on a general location or area of the user device when making a 911 call. For example, the location-accuracy compliance module 206 can use one or more decision engines to select location data for a user device located in the greater Seattle area, and the location-accuracy compliance module 206 can use one or more other decision engines to select location data for another user device located in the greater Denver area. As another example, the location-accuracy compliance module 206 can use one or more decision engines to select location data for a user device located in a dense urban environment, and the location-accuracy compliance module 206 can use one or more other decision engines to select location data for another user device located in a sparse rural environment.

In some embodiments, a plurality of decision engines may be distributed within the cellular communications network to analyze and process location data, as described herein. In at least one embodiment, the distribution of decision engines may be employed based on the location data sources being anchored at different network functions. For example, one or more sources may be anchored on one network function, while other sources may be anchored on another network function (e.g., terminating HTTPS ports). Also, a plurality of decision engines may be distributed within the cellular communications network if the computational complexity of a centralized decision engine is too high. Thus, a combination of network or mobile computing devices and/or mobile-based locations can assists in the deployment of the decision engines.

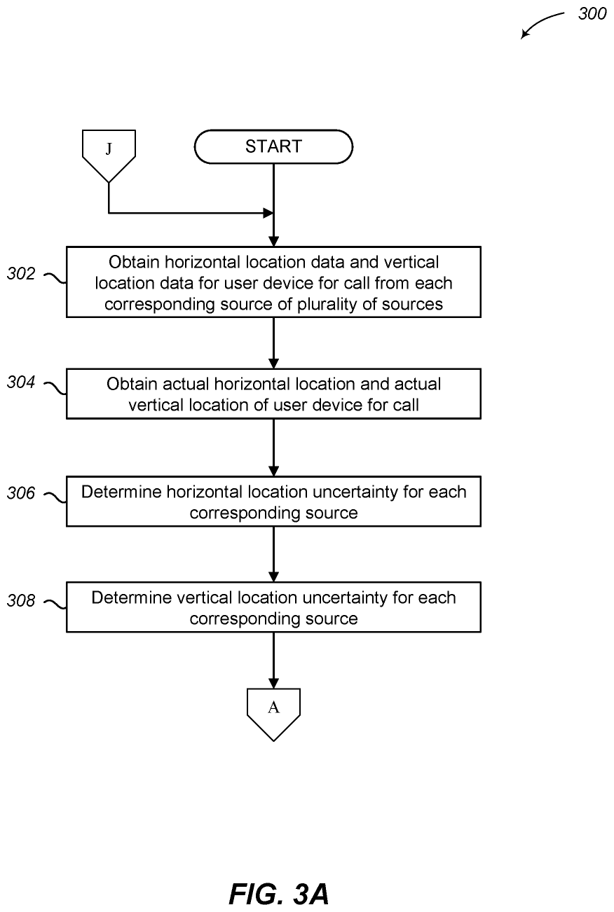

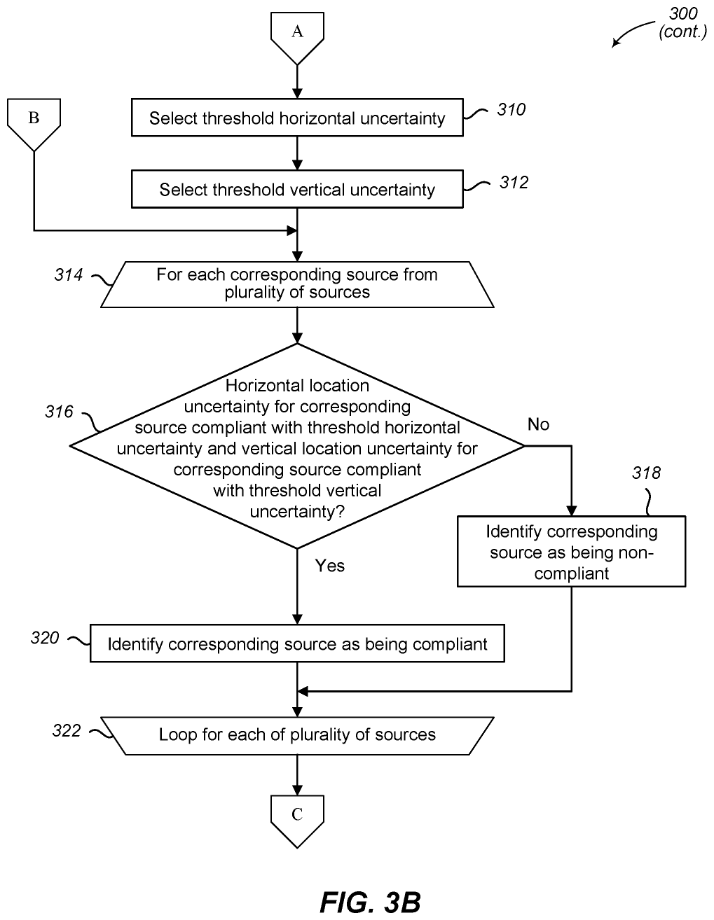

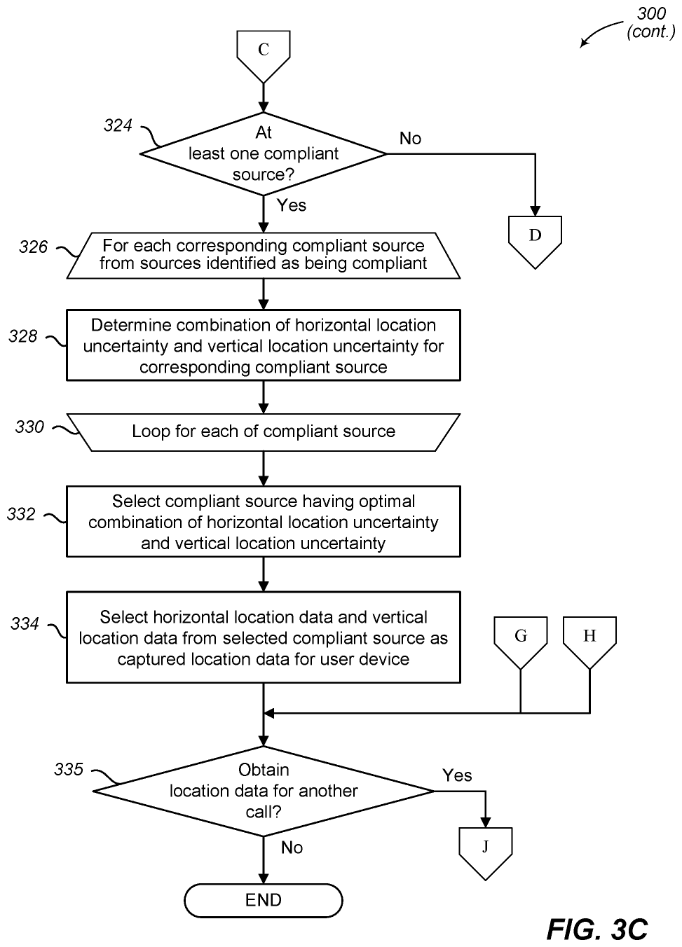

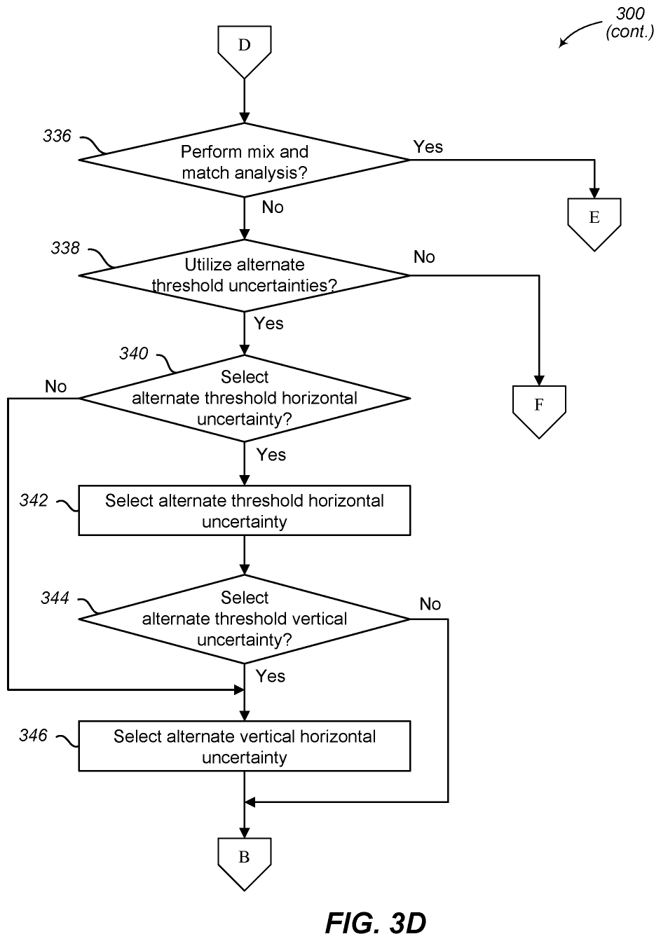

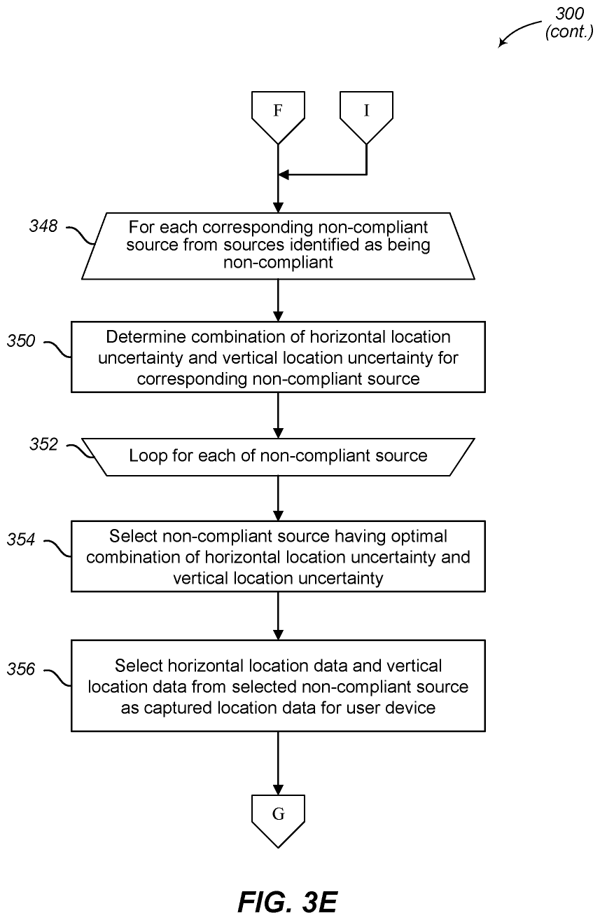

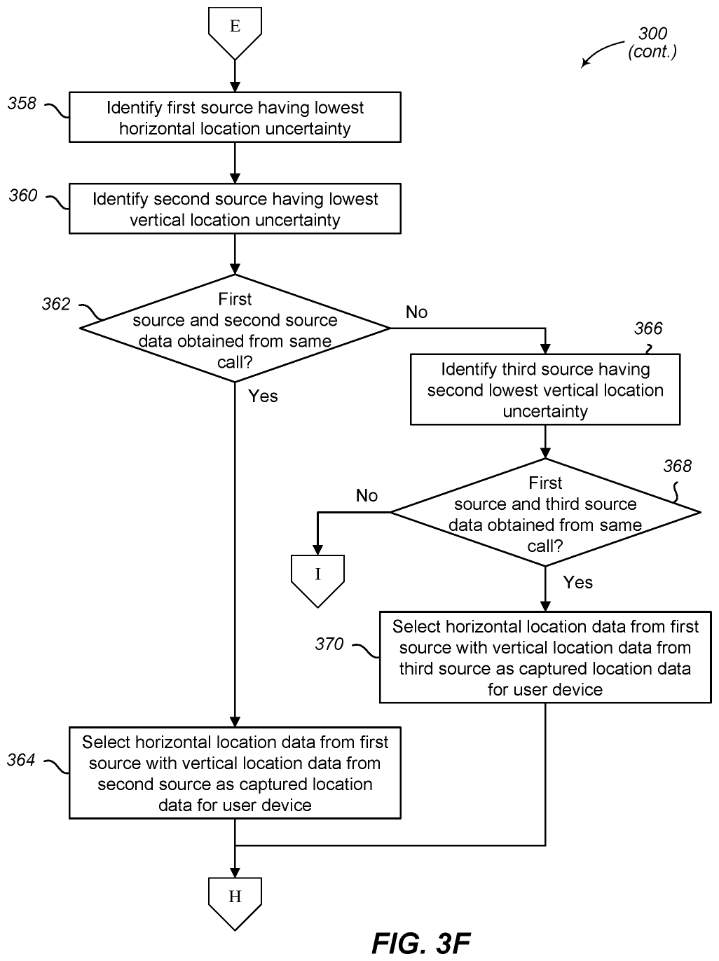

FIGS. 3A-3F illustrates a logical flow diagram showing one embodiment of a process 300 for dynamically obtaining and selecting location source data for 911 calls in accordance with embodiments described herein. In at least one of various embodiments, process 300 may be implemented by or executed via circuitry or on one or more computing devices, such as mobile-device-location-compliance computing device 102 in FIGS. 1 and 2. Although process 300 is described with reference to dynamically obtaining and selecting location source data for 911 calls, embodiments are not so limited. In some embodiments, process 300 may be employed to dynamically obtain and select location source data for other location-based services, devices, or systems, such as, but not limited to, law enforcement devices and tracking, gaming applications, social media applications, etc.

Process 300 begins, after a start block in FIG. 3A, at block 302, where horizontal location data and vertical location data are obtained from each of a plurality of sources for a user device associated with a 911 call. The 911 call may be an actual 911 call, a simulated 911 call, or a test 911 call from a known location. As described herein, the location data may be generated and provided by location sources on or employed by the user device, or the location data may be generated or determined by the network itself, or generated using a hybrid system, or some combination thereof. In some embodiments, the horizontal location data and vertical location data from a plurality of sources can be provided to a location engine for processing.

Process 300 proceeds, after block 302, to block 304, where an actual horizontal location and an actual vertical location are obtained for the user device for the call. In some embodiments, the actual horizontal location and the actual vertical location may be input by an administrator based on the known location of the user device when the 911 call is made. In other embodiments, a precise positioning device, such as a highly accurate GPS device, may be used to obtain the actual horizontal location or the actual vertical location or both. In various embodiments block 304 may be optional and may not be performed.

Process 300 continues, after block 304, at block 306, where a horizontal location uncertainty is determined for each source from which horizontal location data was obtained. The horizontal location uncertainty for a corresponding source may be obtained from the corresponding source itself. In various embodiments, the corresponding source may provide the horizontal location uncertainty along with the horizontal location data. In other embodiments, the horizontal location uncertainty may be determined based on a comparison between the horizontal location data from the corresponding source to the actual horizontal location of the user device. In at least one embodiment, the horizontal location uncertainty is a distance value in meters indicating how far off the horizontal location data is from the actual horizontal location, or an estimate of how far off the corresponding source calculates the horizontal location data to be from the actual horizontal location.

Process 300 proceeds, after block 306, to block 308, where a vertical location uncertainty is determined for each source from which vertical location data was obtained. The vertical location uncertainty for a corresponding source may be obtained from the corresponding source itself. In various embodiments, the corresponding source may provide the vertical location uncertainty along with the vertical location data. In other embodiments, the vertical location uncertainty may be determined based on a comparison between the vertical location data from the corresponding source to the actual vertical location of the user device. In at least one embodiment, the vertical location uncertainty is a distance value in meters indicating how far off the vertical location data is from the actual vertical location, or an estimate of how far off the corresponding source calculates the vertical location data to be from the actual vertical location.

Process 300 continues, after block 308, at block 310 in FIG. 3B, where a threshold horizontal uncertainty is selected. In at least one embodiment, the threshold horizontal uncertainty may be set as a current FCC horizontal uncertainty requirement, such as 50 meters.

Process 300 proceeds, after block 310, to block 312, where a threshold vertical uncertainty is selected. In at least one embodiment, the threshold vertical uncertainty may be set as a current FCC vertical uncertainty requirement, such as 3.0 meters.

Process 300 continues, after block 312, at block 314, where each corresponding source from the plurality of sources is processed.

For each corresponding source, process 300 proceeds after block 314 to decision block 316, where a determination is made whether location data for the corresponding source is compliant with the selected threshold uncertainties.

First, the horizontal location uncertainty for the corresponding source is compared with the selected threshold horizontal uncertainty. If the horizontal location uncertainty meets, satisfies, or is within the selected threshold horizontal uncertainty, then the horizontal location uncertainty for the corresponding source is compliant with the selected threshold horizontal uncertainty; otherwise, the horizontal location uncertainty for the corresponding source is not compliant with the selected threshold horizontal uncertainty. For example, if the horizontal location uncertainty for the corresponding source is 23 meters, and the selected threshold horizontal uncertainty is 50 meters, then the horizontal location uncertainty for that corresponding source is compliant with the selected threshold horizontal uncertainty. Conversely, if the horizontal location uncertainty for the corresponding source is 51 meters, and the selected threshold horizontal uncertainty is 50 meters, then the horizontal location uncertainty for that corresponding source is not compliant with the selected threshold horizontal uncertainty.

Second, the vertical location uncertainty for the corresponding source is compared with the selected threshold vertical uncertainty. If the vertical location uncertainty meets, satisfies, or is within the selected threshold vertical uncertainty, then the vertical location uncertainty for the corresponding source is compliant with the selected threshold vertical uncertainty; otherwise, the vertical location uncertainty for the corresponding source is not compliant with the selected threshold vertical uncertainty. For example, if the vertical location uncertainty for the corresponding source is 2.3 meters, and the selected threshold vertical uncertainty is 3.0 meters, then the vertical location uncertainty for that corresponding source is compliant with the selected threshold vertical uncertainty. Conversely, if the vertical location uncertainty for the corresponding source is 3.3 meters, and the selected threshold vertical uncertainty is 3.0 meters, then the vertical location uncertainty for that corresponding source is not compliant with the selected threshold vertical uncertainty.

If both, the horizontal location uncertainty and the vertical location uncertainty, are compliant for the corresponding source, then process 300 proceeds from decision block 316 to block 320, where the corresponding source is identified as being compliant. But if the horizontal location uncertainty is not compliant, or the vertical location uncertainty is not compliant, or both are not compliant, then process 300 proceeds from decision block 316 to block 318, where the corresponding source is identified as being non-compliant.

After block 320 and block 318, process 300 proceeds to block 322, which loops to block 314 to process each of the plurality of sources to determine if they are compliant or non-compliant.

After each of the plurality of sources is processed and identified as being compliant or non-compliant, process 300 proceeds to decision block 324 in FIG. 3C. At decision block 324, a determination is made whether there is at least one compliant source identified at block 320 in FIG. 3B. If there is at least one compliant source, then process 300 flows to block 326; otherwise, process 300 proceeds to decision block 336 in FIG. 3D.

At block 326, each corresponding compliant source from the at least one compliant source is processed.

For each corresponding compliant source, process 300 proceeds after block 326 to block 328, where a combination of horizontal location uncertainty and vertical location uncertainty for the corresponding compliant source is determined. In some embodiments, the combination may be referred to as the combined uncertainty score and determined by the square root of the sum of the square of the horizontal location uncertainty and the square of the vertical location uncertainty, or

$${{X}_{i}}^{2} = {{A}_{i}}^{2} + {{B}_{i}}^{2} ,$$

i is the corresponding compliant source;
Xᵢ is the combined uncertainty score for a corresponding compliant source;
Aᵢ is the horizontal location uncertainty for a corresponding compliant source; and
Bᵢ is the vertical location uncertainty for a corresponding compliant source.

Embodiments are not limited to this equation, and other algorithms may be used to determine the combined uncertainty score. For example, the combined uncertainty score may be the volume of a cylinder created by the uncertainty (e.g., Combined uncertainty score=π(horizontal location uncertainty)²*2(vertical location uncertainty)).

After block 328 process 300 proceeds to block 330, which loops to block 326 to process each of compliant source to determine a combined score for each compliant source.

After each compliant source is processed and the combined uncertainty score is determined for each compliant source, process 300 proceeds to block 322. At block 332, a compliant source having an optimal combined uncertainty score, or optimal combination of horizontal location uncertainty and vertical location uncertainty, is selected. In at least one embodiment, the optimal compliant source is the compliant source having a lowest combined uncertainty score relative to the combined uncertainty scores of the other compliant sources.

In other embodiments, the optimal compliant source may be selected by employing a “playoff-style” binary tree analysis among sources. For example, a first combined uncertainty score for a first compliant source may be compared to a second combined uncertainty score for a second compliant source, where a best or lowest combined uncertainty score is deemed the “first winner.” A third combined uncertainty score for a third compliant source may then be compared to a fourth combined uncertainty score for a fourth compliant source, where a best or lowest combined uncertainty score is deemed the “second winner.” The combined uncertainty score for the first winner may then be compared to the combined uncertainty score for the second winner, where a best or lowest combined uncertainty score is deemed the optimal source. Such a “playoff-style” analysis may be performed among all or a subset of the compliant sources.

Process 300 proceeds, after block 332, to block 334, where the horizontal location data and the vertical location data of the selected optimal compliant source are selected as the captured location data for the user device. This captured location data for the user device is the location data that is or would be provided to the 911 dispatcher, which is used to determine if the cellular communications network satisfies the location reporting accuracy requirements. In some embodiments, this captured location data for the user device is provided to the 911 dispatcher. In other embodiments, this captured location data for the user device is combined with other captured location data for other user devices to determine if the cellular communications network satisfies a required accuracy percentage for a plurality of 911 calls (or simulated 911 calls).

Process 300 continues, after block 334, at decision block 335, where a determination is made whether to obtain location data for another call. In various embodiments, location data from a plurality of sources for a plurality of calls are obtained and processed via process 300. In some embodiments, the plurality of calls are from a plurality of separate or distinct user devices. In other embodiments, some or all of the plurality of calls may be made by the same user device, but from different locations. In this way, different locations can be tested to determine 911 location compliance of the cellular communications network. If other location data for another call is obtained, process 300 loops to block 302 in FIG. 3A; otherwise, process 300 terminates or otherwise returns to a calling process to perform other actions.

If, at decision block 324 in FIG. 3C, there are no compliant sources, then process 300 proceeds from decision block 324 to decision block 336 in FIG. 3D.

At decision block 336, a determination is made whether a mix and match analysis is performed on the non-compliant sources. In some embodiments, an administrator may provide input or select whether the mix and match analysis is performed when there are no compliant sources for the user device. In other embodiments, the mix and match analysis may be performed if, after processing location data for a plurality of user devices via process 300, the cellular communications network fails to satisfy the required accuracy percentage for a plurality of 911 calls (e.g., less than 80 percent of the 911 calls have location data that meet the 50 meter horizontal uncertainty requirement and the 3.0 meter vertical uncertainty requirement). If mix and match analysis is to be performed, process 300 proceeds to block 358 in FIG. 3F; otherwise, process flows to decision block 338 in FIG. 3D.

At decision block 338, a determination is made whether alternate threshold uncertainties are utilized. In some embodiments, an administrator may provide input or select whether alternate threshold uncertainties are to be utilized when there are no compliant sources for the user device. In other embodiments, the alternate threshold uncertainties may be utilized if, after processing location data for a plurality of user devices via process 300, the cellular communications network fails to satisfy the required accuracy percentage for a plurality of 911 calls (e.g., less than 80 percent of the 911 calls have location data that meet the 50 meter horizontal uncertainty requirement and the 3.0 meter vertical uncertainty requirement).

For example, if 95% of calls meet the threshold horizontal uncertainty, but 70% of calls meet the threshold vertical uncertainty, using an alternate threshold horizontal uncertainty may identify additional sources having compliant vertical location uncertainty (assuming the compliance requirement is 80%). In this way, the number of calls meeting the threshold horizontal uncertainty may decrease, such as to 85%, but the number of calls meeting the threshold vertical uncertainty may increase to be over 80%-resulting in both thresholds being compliant. Conversely, using an alternate threshold vertical uncertainty may decrease the number of calls meeting the threshold vertical uncertainty, but increase the number of calls meeting the threshold horizontal uncertainty to result in both thresholds being compliant.

If alternate threshold uncertainties are to be utilized, process 300 proceeds to decision block 340; otherwise, process flows to block 348 in FIG. 3E.

At decision block 340 in FIG. 3D, a determination is made whether an alternate threshold horizontal uncertainty is selected. In some embodiments, an administrator may provide input or select whether an alternate threshold horizontal uncertainty is to be selected when there are no compliant sources for the user device. If an alternate threshold horizontal uncertainty is to be selected, process 300 proceeds to block 342; otherwise, process flows to block 346.

At block 342, an alternate threshold horizontal uncertainty is selected. In some embodiments, the alternate threshold horizontal uncertainty may be referred to as an “almost acceptable” horizontal uncertainty. For example, if the initial threshold horizontal uncertainty selected at block 310 is 50 meters, then the alternate threshold horizontal uncertainty may be 52.5 meters, or 55 meters, or some other selected uncertainty distance value that is greater than the initially required horizontal uncertainty.

Process 300 proceeds, after block 342, to decision block 344, where a determination is made whether an alternate threshold vertical uncertainty is selected. In some embodiments, an administrator may provide input or select whether an alternate threshold vertical uncertainty is to be selected when there are no compliant sources for the user device. If an alternate threshold vertical uncertainty is to be selected, process 300 proceeds to block 346; otherwise, process flows to block 314 in FIG. 3B.

At block 346, an alternate threshold vertical uncertainty is selected. In some embodiments, the alternate threshold vertical uncertainty may be referred to as an “almost acceptable” vertical uncertainty. For example, if the initial threshold vertical uncertainty selected at block 312 is 3.0 meters, then the alternate threshold horizontal uncertainty may be 3.3 meters, or 3.5 meters, or some other selected uncertainty distance value that is greater than the initially required vertical uncertainty.

After block 346, or if at decision block 344 no alternate threshold vertical uncertainty is selected, process 300 loops to block 314 in FIG. 3B. In some situations, only an alternate threshold horizontal uncertainty is selected at block 342 and the initially threshold vertical uncertainty selected at block 312 is used again. In other situations, only an alternate threshold vertical uncertainty is selected at block 346 and the initially threshold horizontal uncertainty selected at block 310 is used again. In yet other situations, both an alternate threshold horizontal uncertainty is selected at block 342 and an alternate threshold vertical uncertainty is selected at block 346. By looping to block 314, each corresponding source of the plurality of sources may be re-processed and re-analyzed to determine if a source is compliant with respect to the selected alternate threshold uncertainties. Selecting an alternate threshold horizontal uncertainty may improve the overall compliance for a plurality of user devices for a plurality of calls.

If, at decision block 338 in FIG. 3D, no alternate threshold uncertainty is utilized, then process 300 flows from decision block 338 to block 348 in FIG. 3E. At block 348, each corresponding non-compliant source from the sources identified as being non-compliant is processed.

For each corresponding non-compliant source, process 300 proceeds after block 348 to block 350, where a combination of horizontal location uncertainty and vertical location uncertainty for the corresponding non-compliant source is determined. In various embodiments, block 438 may employ embodiments of block 328 in FIG. 3C to determine a combined uncertainty score.

After block 350, process 300 proceeds to block 352, which loops to block 348 to process each of the non-compliant sources to determine a combined uncertainty score for each non-compliant source.

After each of the non-compliant sources is processed and the combined uncertainty score is determined for each non-compliant source, process 300 proceeds to block 354. At block 354, a non-compliant source having an optimal combined uncertainty score, or optimal combination of horizontal location uncertainty and vertical location uncertainty, is selected. In various embodiments, block 354 may employ embodiments of block 334 in FIG. 3C to select an optimal source, but from the non-compliant sources.

Process 300 proceeds, after block 354, to block 356, where the horizontal location data and the vertical location data of the selected non-compliant source are selected as the captured location data for the user device. In various embodiments, block 356 employs embodiments similar block 334 in FIG. 3C to utilize this selected, captured location data for the user device to determine if the cellular communications network satisfies the location reporting accuracy requirements.

After block 356, process 300 flows to decision block 335 in FIG. 3C to determine if other location data is obtained for another user device.

If, at decision block 336 in FIG. 3D, a mix and match analysis is to be performed, then process 300 flows from decision block 336 to block 358 in FIG. 3F. At block 358, a first source is identified as having a lowest horizontal location uncertainty (or closest horizontal location uncertainty value to the threshold horizontal uncertainty). In various embodiments, the horizontal location uncertainty from each source is compared with one another to determine which source has the lowest horizontal location uncertainty.

Process 300 proceeds, after block 358, to block 360, where a second source is identified as having a lowest vertical location uncertainty (or closest vertical location uncertainty value to the threshold vertical uncertainty). In various embodiments, the vertical location uncertainty from each source is compared with one another to determine which source has the lowest vertical location uncertainty.

Process 300 continues, after block 360, at decision block 362, where a determination is made whether the horizontal location data of first source and the vertical location data of the second source came from the same call. In some embodiments, the first source and the second source may have similar timestamps indicating that their location data is from a same call. In other embodiments, the horizontal location data of first source and the vertical location data of the second source may be associated with a same identifier of the user device from which the data is collected, which indicates that the first source and the second source are from the same call. If the location data from the first source and the second source are obtained from the same call, then process 300 proceeds to block 364; otherwise, process 300 proceeds to block 366.

At block 364, the horizontal location data of the first source and the vertical location data of the second source are selected as the captured location data for the user device. In various embodiments, block 364 employs embodiments similar block 334 in FIG. 3C to utilize this selected, captured location data for the user device to determine if the cellular communications network satisfies the location reporting accuracy requirements. After block 364, process flows to decision block 335 in FIG. 3C to determine if other location data is obtained for another user device.

If, at decision block 362 in FIG. 3F, the data from first source and the second source are not from the same call, then process 300 flows from decision block 362 to block 366. At block 366, a third source is identified as having a second lowest vertical location uncertainty (or second closest vertical location uncertainty value to the threshold vertical uncertainty). In various embodiments, the vertical location uncertainty from each source is compared with one another to determine which source has the second lowest vertical location uncertainty.

Process 300 continues, after block 366, at decision block 368, where a determination is made whether the horizontal location data of first source and the vertical location data of the third source came from the same call. In various embodiments, decision block 368 may employ embodiments of block 362 to determine if the data from the first source and the third source are from the same call. If the location data from first source and the third source are obtained from the same call, then process 300 proceeds to block 370; otherwise, process 300 proceeds to block 348 in FIG. 3E to select a non-compliant source having an optimal combination of horizontal location uncertainty and vertical location uncertainty.

At block 370 in FIG. 3F, the horizontal location data of the first source and the vertical location data of the third source are selected as the captured location data for the user device. In various embodiments, block 370 employs embodiments similar block 334 in FIG. 3C to utilize this selected, captured location data for the user device to determine if the cellular communications network satisfies the location reporting accuracy requirements. After block 370, process flows to decision block 335 in FIG. 3C to determine if other location data is obtained for another user device.

Although block 366 identifies a third source having a second lowest vertical location uncertainty, embodiments are not so limited. In some embodiments, the third source may be the source having a second lowest horizontal location uncertainty such that decision block determines if the second source and the third source are from the same call. If they are from the same call, then the vertical location data from the second source and the horizontal location data from the third source are selected as the captured location data for the user device.

Moreover, although process 300 is illustrated has having decision blocks to determine if a mix and match analysis is performed or alternate thresholds are used, embodiments are not so limited. In some embodiments, process 300 may terminate after decision block 324 if there are no compliant sources. In this case, a default source of the plurality sources may be selected from which the horizontal location data and the vertical location data are selected as the captured location data for the user device. In other embodiments, decision block 336 and the mix and match analysis may be optional and may not be performed. In yet other embodiments, decision block 338 and the alternate threshold processing may be optional and may not be performed.

In some embodiments and situations, a single source may provide multiple horizontal locations or multiple vertical locations. In such a situation, the last (or most recent in time) captured horizontal location data and the last (or most recent in time) captured vertical location data are selected as the captured location data for the user device. In this way, if the user device is moving around, then the last or most recent location of the user device is obtained.

As mentioned above, although embodiments are primarily described herein as selecting a location of a user device from among multiple sources for a 911 call, embodiments are not so limited. Rather, process 300 and embodiments described herein may be utilized to determine the user device's location for other purposes, such as emergency location apps, location tracking apps, social media apps using location services, search apps, etc.

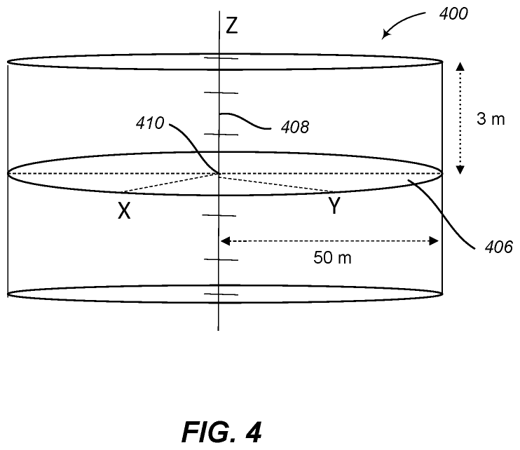

FIG. 4 shows a use case visualization of location accuracy compliance requirements 400 in accordance with embodiments described herein. The location accuracy compliance requirement 400 is defined by a threshold horizontal uncertainty 406 and a threshold vertical uncertainty 408. In this example, the threshold horizontal uncertainty 406 is 50 meters in any horizontal direction (x,y axis) from an actual location 410 of a user device making a 911 call. And the threshold vertical uncertainty 408 is plus or minus 3 meters in a vertical direction (z axis) from the actual location 410 of the user device making the 911 call. As a result, the location accuracy compliance requirements 400 is illustrated as a cylinder having a radius of 50 meters and a height of 6 meters. Although threshold horizontal uncertainty 406 is illustrated as 50 meters and the threshold vertical uncertainty 408 is illustrated as 3.0 meters, embodiments are not so limited and other thresholds may be used.

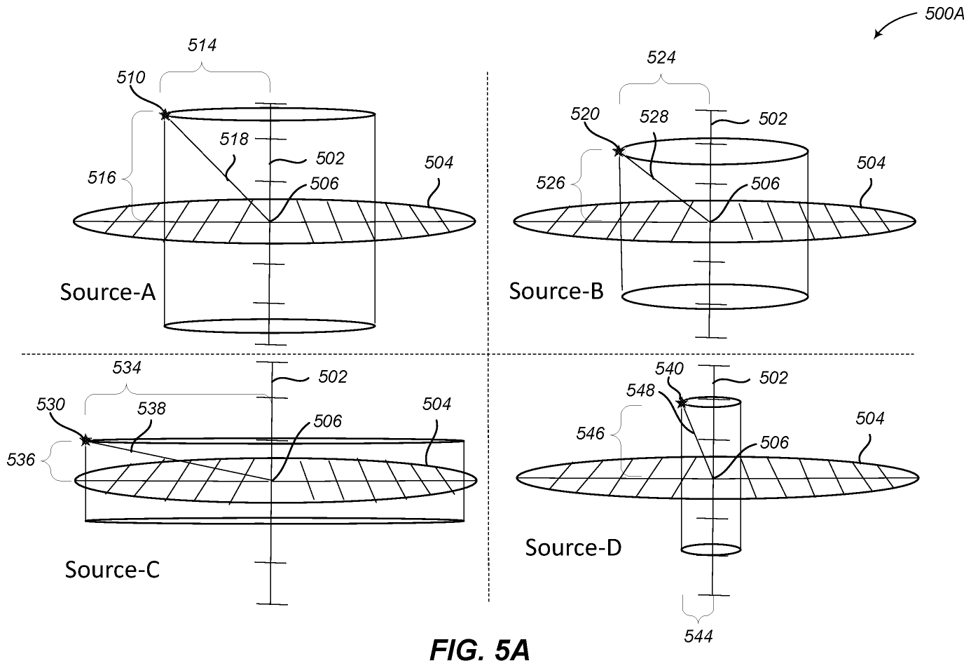

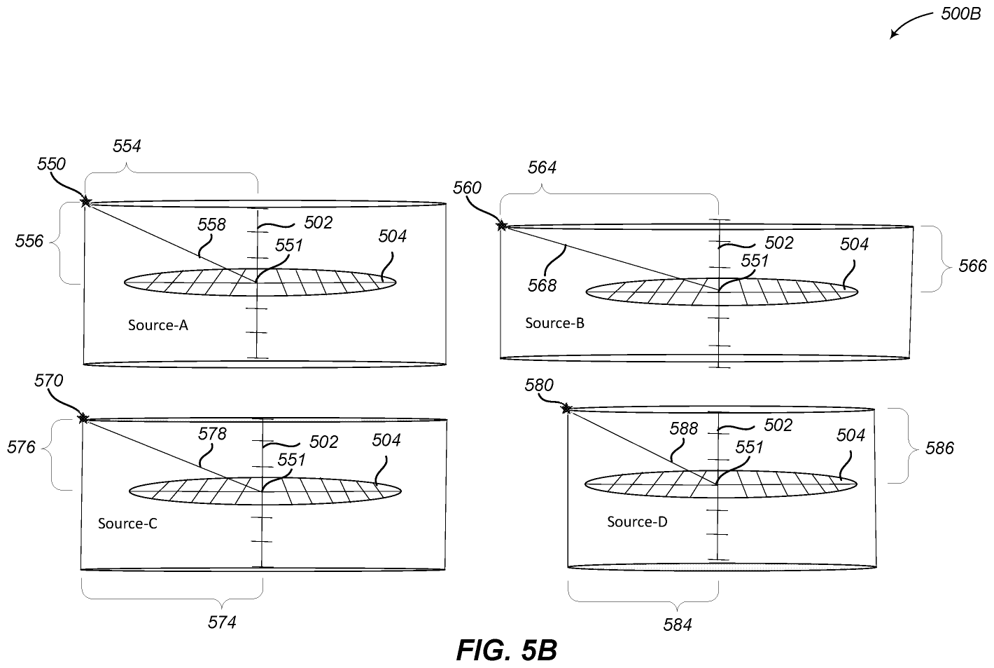

FIGS. 5A-5B show use case visualizations of location uncertainty in accordance with embodiments described herein. Example 500A in FIG. 5A includes location data from four sources (Source-A, Source-B, Source-C, and Source-D) during a single 911 call from a user device (e.g., user device 124 in FIG. 1). In this example, a user device makes a 911 call (or simulated 911 call) from a known actual location 506.

Source-A determines that the user device is at location 510 with a horizontal location uncertainty 514 and a vertical location uncertainty 516. In some embodiments, Source-A may provide the horizontal location uncertainty 514, or the vertical location uncertainty 516, or both. In other embodiments, the location 510 may be compared to the actual location 506 to determine the horizontal location uncertainty 514 or the vertical location uncertainty 516, or both. The horizontal location uncertainty 514 is compared to threshold horizontal uncertainty 504, which may be an embodiment of threshold horizontal uncertainty 406 in FIG. 4. And the vertical location uncertainty 516 is compared to threshold vertical uncertainty 502, which may be an embodiment of threshold vertical uncertainty 408 in FIG. 4. Because the horizontal location uncertainty 514 meets or satisfies the threshold horizontal uncertainty 504 and the vertical location uncertainty 516 meets or satisfies the threshold vertical uncertainty 502, Source-A is identified in this example as being compliant.

Source-B determines that the user device is at location 520 with a horizontal location uncertainty 524 and a vertical location uncertainty 526. In some embodiments, Source-B may provide the horizontal location uncertainty 514, or the vertical location uncertainty 516, or both, or null values. In other embodiments, the location 520 may be compared to the actual location 506 to determine the horizontal location uncertainty 524 or the vertical location uncertainty 526, or both. The horizontal location uncertainty 524 is compared to threshold horizontal uncertainty 504. And the vertical location uncertainty 526 is compared to threshold vertical uncertainty 502. Because the horizontal location uncertainty 524 meets or satisfies the threshold horizontal uncertainty 504 and the vertical location uncertainty 526 meets or satisfies the threshold vertical uncertainty 502, Source-B is identified in this example as being compliant.

Source-C determines that the user device is at location 530 with a horizontal location uncertainty 534 and a vertical location uncertainty 536. In some embodiments, Source-C may provide the horizontal location uncertainty 534, or the vertical location uncertainty 536, or both. In other embodiments, the location 530 may be compared to the actual location 506 to determine the horizontal location uncertainty 534 or the vertical location uncertainty 536, or both. The horizontal location uncertainty 534 is compared to threshold horizontal uncertainty 504. And the vertical location uncertainty 536 is compared to threshold vertical uncertainty 502. Because the horizontal location uncertainty 534 meets or satisfies the threshold horizontal uncertainty 504 and the vertical location uncertainty 536 meets or satisfies the threshold vertical uncertainty 502, Source-C is identified in this example as being compliant.

Source-D determines that the user device is at location 540 with a horizontal location uncertainty 544 and a vertical location uncertainty 546. In some embodiments, Source-D may provide the horizontal location uncertainty 544, or the vertical location uncertainty 546, or both. In other embodiments, the location 540 may be compared to the actual location 506 to determine the horizontal location uncertainty 544 or the vertical location uncertainty 546, or both. The horizontal location uncertainty 544 is compared to threshold horizontal uncertainty 504. And the vertical location uncertainty 546 is compared to threshold vertical uncertainty 502. Because the horizontal location uncertainty 544 meets or satisfies the threshold horizontal uncertainty 504 and the vertical location uncertainty 546 meets or satisfies the threshold vertical uncertainty 502, Source-D is identified in this example as being compliant.

In this illustrated example, each source is identified as being compliant. Accordingly, a most optimal source is determined. By employing embodiments described herein, a combined score for each source is determined. For example, combined score 518 is determined for Source-A from a combination of horizontal location uncertainty 514 and vertical location uncertainty 516, combined score 528 is determined for Source-B from a combination of horizontal location uncertainty 524 and vertical location uncertainty 526, combined score 538 is determined for Source-C from a combination of horizontal location uncertainty 534 and vertical location uncertainty 536, and combined score 548 is determined for Source-D from a combination of horizontal location uncertainty 544 and vertical location uncertainty 546. In some embodiments, the combined score may be represented as a three-dimensional cylinder. Combined score 518, combined score 528, combined score 538, and combined score 548 are then compared to identify the optimal source. For example, the source with the lowest combined score (e.g., Source-D in this example) may be identified as the optimal source.

Example 500B in FIG. 5B is similar to Example 500A in FIG. 5A, but with non-compliant sources. In this illustration, example 500B includes location data from four sources (Source-A, Source-B, Source-C, and Source-D) during a single 911 call from a user device (e.g., user device 124 in FIG. 1). In this example, a user device makes a 911 call (or simulated 911 call) for a known actual location 551. Source-A, Source-B, Source-C, and Source-D illustrated in FIG. 5B may be the same sources or different sources from Source-A, Source-B, Source-C, and Source-D illustrated in FIG. 5A.

Source-A determines that the user device is at location 550 with a horizontal location uncertainty 554 and a vertical location uncertainty 556. In some embodiments, Source-A may provide the horizontal location uncertainty 554, or the vertical location uncertainty 556, or both. In other embodiments, the location 550 may be compared to the actual location 551 to determine the horizontal location uncertainty 554 or the vertical location uncertainty 556, or both. The horizontal location uncertainty 554 is compared to threshold horizontal uncertainty 504, which may be an embodiment of threshold horizontal uncertainty 406 in FIG. 4. And the vertical location uncertainty 556 is compared to threshold vertical uncertainty 502, which may be an embodiment of threshold vertical uncertainty 408 in FIG. 4. Because the horizontal location uncertainty 554 fails to meet or satisfy the threshold horizontal uncertainty 504, Source-A is identified in this example as being non-compliant.

Source-B determines that the user device is at location 560 with a horizontal location uncertainty 564 and a vertical location uncertainty 566. In some embodiments, Source-B may provide the horizontal location uncertainty 564, or the vertical location uncertainty 566, or both. In other embodiments, the location 560 may be compared to the actual location 551 to determine the horizontal location uncertainty 564 or the vertical location uncertainty 566, or both. The horizontal location uncertainty 564 is compared to threshold horizontal uncertainty 504. And the vertical location uncertainty 566 is compared to threshold vertical uncertainty 502. Because the horizontal location uncertainty 564 fails to meet or satisfy the threshold horizontal uncertainty 504, Source-B is identified in this example as being non-compliant.

Source-C determines that the user device is at location 570 with a horizontal location uncertainty 574 and a vertical location uncertainty 576. In some embodiments, Source-C may provide the horizontal location uncertainty 574, or the vertical location uncertainty 576, or both. In other embodiments, the location 570 may be compared to the actual location 551 to determine the horizontal location uncertainty 574 or the vertical location uncertainty 576, or both. The horizontal location uncertainty 574 is compared to threshold horizontal uncertainty 574. And the vertical location uncertainty 576 is compared to threshold vertical uncertainty 502. Because the horizontal location uncertainty 574 fails to meet or satisfy the threshold horizontal uncertainty 504, Source-C is identified in this example as being non-compliant.

Source-D determines that the user device is at location 580 with a horizontal location uncertainty 584 and a vertical location uncertainty 586. In some embodiments, Source-D may provide the horizontal location uncertainty 584, or the vertical location uncertainty 586, or both. In other embodiments, the location 580 may be compared to the actual location 551 to determine the horizontal location uncertainty 584 or the vertical location uncertainty 586, or both. The horizontal location uncertainty 584 is compared to threshold horizontal uncertainty 504. And the vertical location uncertainty 586 is compared to threshold vertical uncertainty 502. Because the horizontal location uncertainty 584 fails to meet or satisfy the threshold horizontal uncertainty 504, Source-D is identified in this example as being non-compliant.

In this illustrated example, each source is identified as being non-compliant. Accordingly, a most optimal non-compliant source is determined. By employing embodiments described herein, a combined score for each source is determined. For example, combined score 558 is determined for Source-A from a combination of horizontal location uncertainty 554 and vertical location uncertainty 556, combined score 568 is determined for Source-B from a combination of horizontal location uncertainty 564 and vertical location uncertainty 566, combined score 578 is determined for Source-C from a combination of horizontal location uncertainty 574 and vertical location uncertainty 576, and combined score 588 is determined for Source-D from a combination of horizontal location uncertainty 584 and vertical location uncertainty 586. In some embodiments, the combined score may be represented as a three-dimensional cylinder. Combined score 558, combined score 568, combined score 578, and combined score 588 are then compared to identify the optimal non-compliant source. For example, the source with the lowest combined score (e.g., Source-D in this example) may be identified as the optimal non-compliant source.

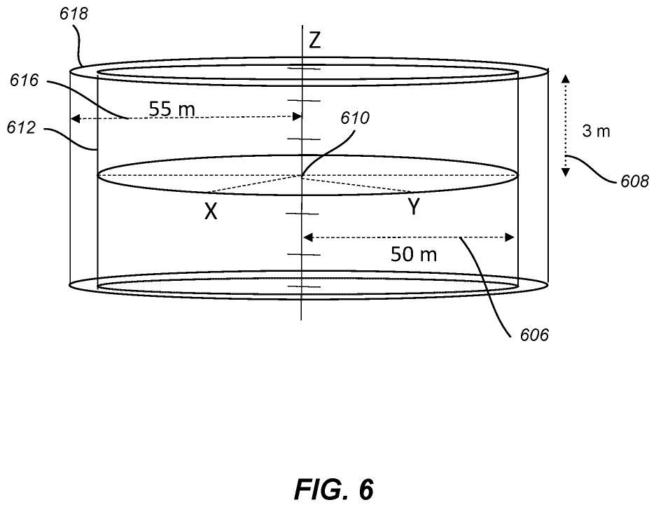

FIG. 6 shows a use case visualization of alternate location accuracy compliance requirements in accordance with embodiments described herein. The initial location accuracy compliance requirement 612 is similar to the location accuracy compliance requirement 400 in FIG. 4. Accordingly, the initial location accuracy compliance requirement 612 is defined by an initial threshold horizontal uncertainty 606 and an initial threshold vertical uncertainty 608. In this example, the initial threshold horizontal uncertainty 606 is 50 meters in any horizontal direction (x,y axis) from an actual location 610 of a user device making a 911 call. And the initial threshold vertical uncertainty 608 is plus or minus 3 meters in a vertical direction (z axis) from the actual location 610 of the user device making the 911 call. As a result, the initial location accuracy compliance requirements 612 is illustrated as a cylinder having a radius of 50 meters and a height of 6 meters.

By employing embodiments described herein, an alternate threshold horizontal uncertainty or an alternate threshold vertical uncertainty may be selected. In this illustration, an alternate threshold horizontal uncertainty 616 is selected, while maintaining the initial threshold vertical uncertainty 608. In this example, the alternate threshold horizontal uncertainty 616 is 55 meters in any horizontal direction (x,y axis) from the actual location 610 of the user device making the 911 call. As a result, the alternate location accuracy compliance requirements 618 is illustrated as a cylinder having a radius of 55 meters and a height of 6 meters. As discussed herein, using alternate threshold uncertainties can result in more compliant location data as a whole among a plurality of calls.

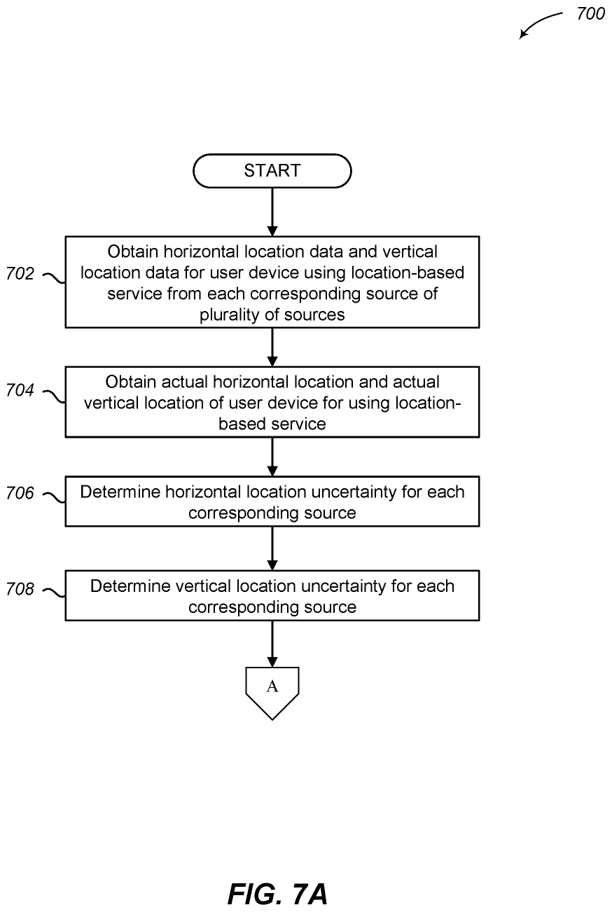

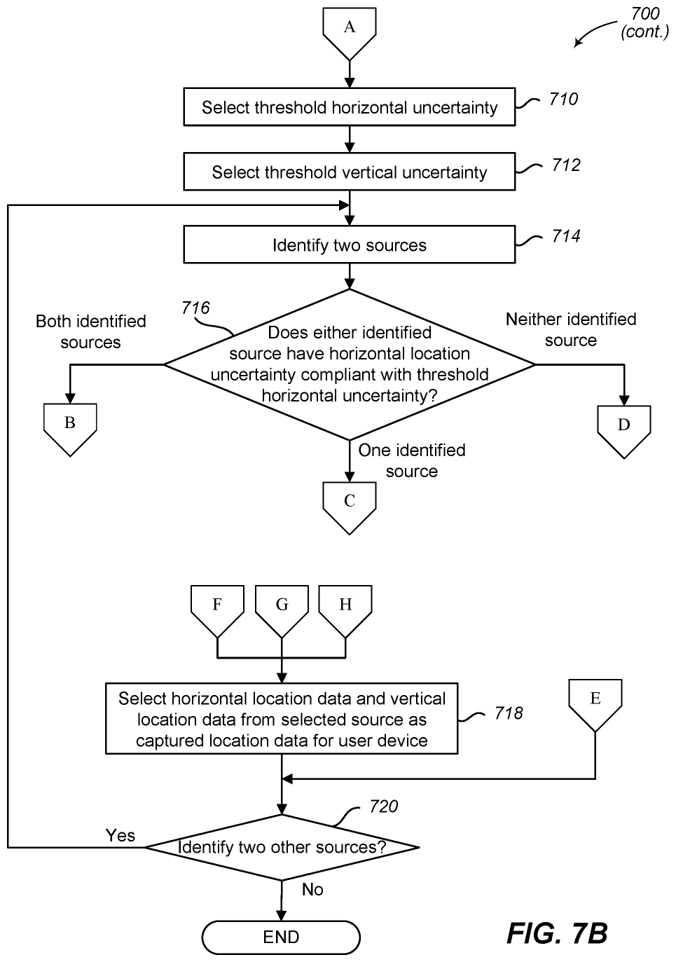

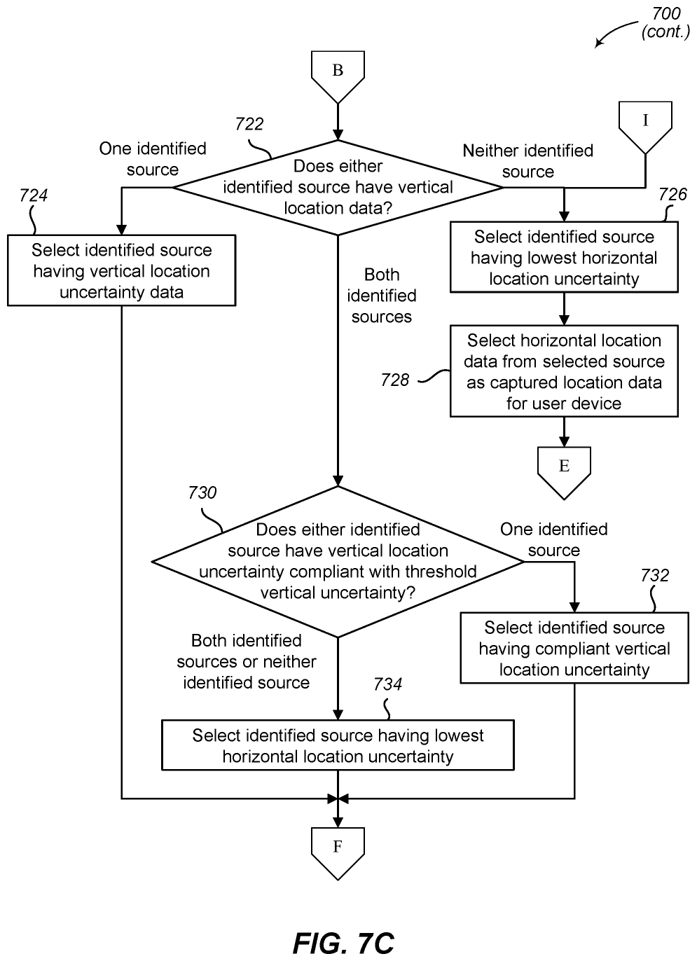

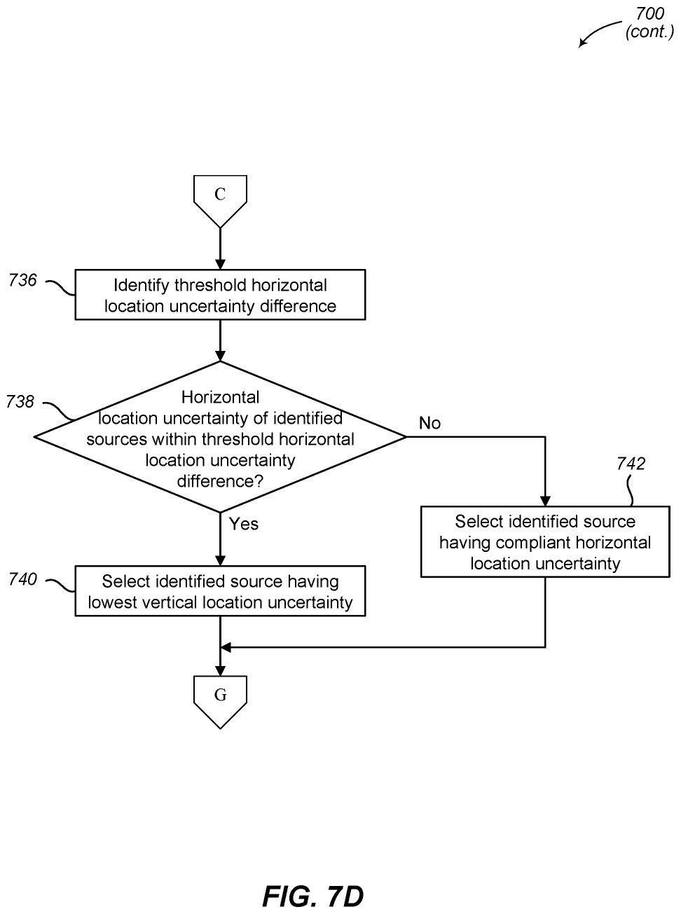

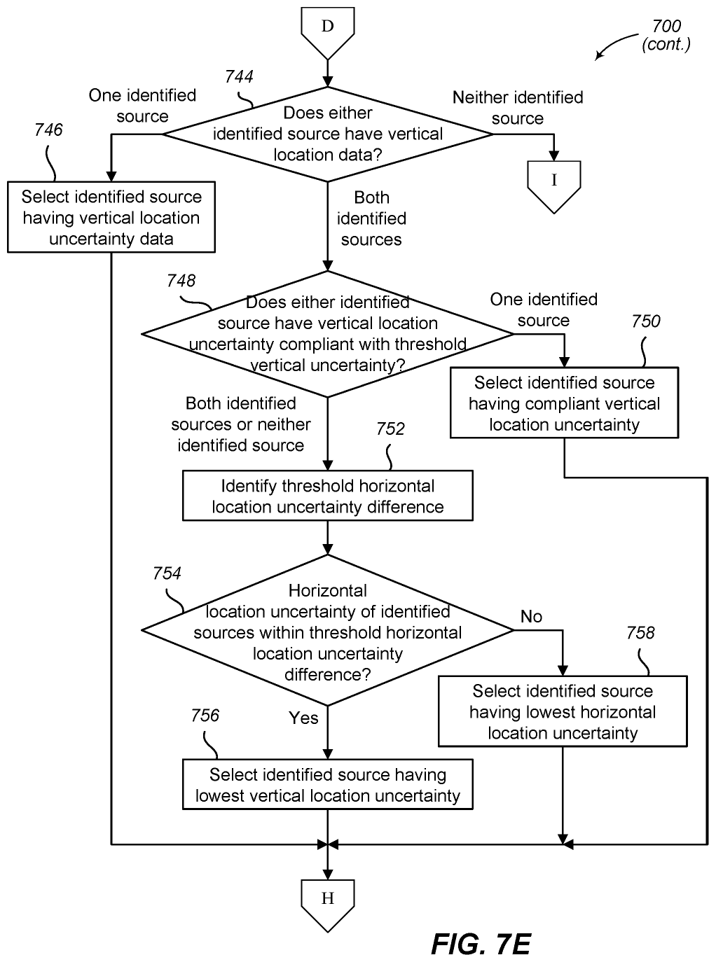

FIGS. 7A-7E illustrate a logical flow diagram showing another embodiment of a process 700 for dynamically obtaining and selecting location source data for location-based services in accordance with embodiments described herein. In at least one of various embodiments, process 700 may be implemented by or executed via circuitry or on one or more computing devices, such as mobile-device-location-compliance computing device 102 in FIGS. 1 and 2.

Process 700 begins, after a start block in FIG. 7A, at block 702, where horizontal location data and vertical location data are obtained from each of a plurality of sources for a user device using a location-based service. In various embodiments, block 702 may employ embodiments similar to block 302 in FIG. 3A.

Process 700 proceeds, after block 702, to block 704, where an actual horizontal location and an actual vertical location are obtained for the user device for the call. In various embodiments, block 704 may employ embodiments similar to block 304 in FIG. 3A.

Process 700 continues, after block 704, at block 706, where a horizontal location uncertainty is determined for each source from which horizontal location data was obtained. In various embodiments, block 706 may employ embodiments similar to block 306 in FIG. 3A.

Process 700 proceeds, after block 306, to block 308, where a vertical location uncertainty is determined for each source from which vertical location data was obtained. In various embodiments, block 708 may employ embodiments similar to block 308 in FIG. 3A.

Process 700 continues, after block 708, at block 710 in FIG. 7B, where a threshold horizontal uncertainty is selected. In various embodiments, block 710 may employ embodiments similar to block 310 in FIG. 3B.

Process 700 proceeds, after block 710, to block 712, where a threshold vertical uncertainty is selected. In various embodiments, block 712 may employ embodiments similar to block 312 in FIG. 3B.

Process 700 continues, after block 712, at block 714, where two of the plurality of sources are identified. In various embodiments, each combination of two sources from the plurality of sources may be identified and processed. In this way, each source is compared to each other source to find a most optimum source from the plurality of sources from which location data is obtained at block 702.

Process 700 proceeds, after block 714, to decision block 716, where a determination is made whether either of the identified sources has a horizontal location uncertainty that is compliant with the threshold horizontal uncertainty. In various embodiments, decision block 716 may employ embodiments similar to decision block 316 in FIG. 3B to determine if the horizontal location uncertainty for an identified source is compliant with the threshold horizontal uncertainty.

If the horizontal location uncertainty is compliant for both identified sources, then process 700 proceeds from decision block 716 in FIG. 7B to decision block 722 in FIG. 7C. If the horizontal location uncertainty is compliant for only one identified source, then process 700 proceeds from decision block 716 in FIG. 7B to block 736 in FIG. 7D. But if the horizontal location uncertainty is not compliant for either identified source, then process 700 proceeds from decision block 716 in FIG. 7B to decision block 744 in FIG. 7E.

At decision block 722 in FIG. 7C, a determination is made whether either of the identified sources have vertical location data. If one identified source has vertical location data, then process 700 flows from decision block 722 to block 724, where that identified source is selected such that its horizontal location data and vertical location data are used as captured location data for the user device at block 718 in FIG. 7B. If both identified sources have vertical location data, then process 700 flows from decision block 722 to decision block 730. But if neither identified source has vertical location data, then process 700 flows from decision block 722 to block 726.

At block 726, the identified source having the lowest horizontal location uncertainty between the two identified sources is selected.

Process 700 proceeds, after block 726, to block 728, where the horizontal location data of the selected source is selected as the captured location data for the user device. This captured location data for the user device is the location data that is or would be used by the location-based service (e.g., provided to the 911 dispatcher). After block 728, process 700 flows to decision block 720 in FIG. 7B.

If, at decision block 722 in FIG. 7C, both identified sources have vertical location data, then process 700 flows from decision block 722 to decision block 730. At decision block 730, a determination is made whether either of the identified sources has a vertical location uncertainty that is compliant with the threshold vertical uncertainty. In various embodiments, decision block 730 may employ embodiments similar to decision block 316 in FIG. 3B to determine if the vertical location uncertainty for an identified source is compliant with the threshold vertical uncertainty.

If one identified source has compliant vertical location uncertainty, then process 700 flows from decision block 730 to block 732, where that identified source is selected such that its horizontal location data and vertical location data are used as captured location data for the user device at block 718 in FIG. 7B.

If both identified sources have compliant vertical location uncertainty, or if neither identified source has compliant vertical location uncertainty, then process 700 flows from decision block 730 to block 734, where the identified source having the lowest horizontal location uncertainty is selected such that its horizontal location data and vertical location data are used as captured location data for user device at block 718 in FIG. 7B.

Returning to FIG. 7B, if, at decision block 716, the horizontal location uncertainty is compliant for only one identified source, then process 700 proceeds from decision block 716 in FIG. 7B to block 736 in FIG. 7D.

At block 736, a threshold horizontal location uncertainty difference is identified. The threshold horizontal location uncertainty difference is used as a threshold to determine if the threshold horizontal location uncertainties of the identified sources are similar (i.e., are the threshold horizontal location uncertainties within the threshold horizontal location uncertainty difference), In some embodiments, the threshold horizontal location uncertainty difference may be 10% difference, but other differences or difference values or percentages may also be used.

Process 700 proceeds, after block 736, to decision block 738, where a determination is made whether the threshold horizontal location uncertainties of the identified sources are within the threshold horizontal location uncertainty difference. If yes, then process 700 flows from decision block 738 to block 740, where the identified source having the lowest vertical location uncertainty is selected such that its horizontal location data and vertical location data are used as captured location data for user device at block 718 in FIG. 7B. But if the threshold horizontal location uncertainties of the identified sources are not within the threshold horizontal location uncertainty difference, then process 700 flows from decision block 738 to block 742, where the identified source having the compliant horizontal location uncertainty is selected such that its horizontal location data and vertical location data are used as captured location data for user device at block 718 in FIG. 7B. In this way, the source having the better vertical location uncertainty is selected, even if that source's horizontal location uncertainty is a little worse (i.e., within the threshold horizontal location uncertainty difference) than the other identified source.

Returning to again to FIG. 7B, if, at decision block 716, the horizontal location uncertainty is not compliant for either identified source, then process 700 proceeds from decision block 716 in FIG. 7B to decision block 744 in FIG. 7E.

At decision block 744 in FIG. 7E, a determination is made whether either of the identified sources have vertical location data. If one identified source has vertical location data, then process 700 flows from decision block 744 to block 746, where that identified source is selected such that its horizontal location data and vertical location data are used as captured location data for the user device at block 718 in FIG. 7B. If both identified sources have vertical location data, then process 700 flows from decision block 744 to decision block 748. But if neither identified source has vertical location data, then process 700 flows from decision block 744 to block 726 in FIG. 7C to select the identified source having the lowest horizontal location uncertainty between the two identified sources.

If, at decision block 744 in FIG. 7E, both identified sources have vertical location data, then process 700 flows from decision block 744 to decision block 748. At decision block 748, a determination is made whether either of the identified sources has a vertical location uncertainty that is compliant with the threshold vertical uncertainty. In various embodiments, decision block 748 may employ embodiments similar to decision block 730 in FIG. 7C to determine if the vertical location uncertainty for an identified source is compliant with the threshold vertical uncertainty.

If one identified source has compliant vertical location uncertainty, then process 700 flows from decision block 748 to block 750, where that identified source is selected such that its horizontal location data and vertical location data are used as captured location data for the user device at block 718 in FIG. 7B.

If both identified sources have compliant vertical location uncertainty, or if neither identified source has compliant vertical location uncertainty, then process 700 flows from decision block 748 to block 752.

At block 752, a threshold horizontal location uncertainty difference is identified. In various embodiments, block 752 may employ embodiments of block 736 in FIG. 7D to identify the threshold horizontal location uncertainty difference.

Process 700 proceeds, after block 752, to decision block 754, where a determination is made whether the threshold horizontal location uncertainties of the identified sources are within the threshold horizontal location uncertainty difference. In various embodiments, decision block 754 may employ embodiments of decision block 738 in FIG. 7D. If the threshold horizontal location uncertainties of the identified sources are within the threshold horizontal location uncertainty difference, then process 700 flows from decision block 754 to block 756, where the identified source having the lowest vertical location uncertainty is selected such that its horizontal location data and vertical location data are used as captured location data for user device at block 718 in FIG. 7B. But if the threshold horizontal location uncertainties of the identified sources are not within the threshold horizontal location uncertainty difference, then process 700 flows from decision block 754 to block 758, where the identified source having the lowest horizontal location uncertainty is selected such that its horizontal location data and vertical location data are used as captured location data for user device at block 718 in FIG. 7B. In this way, the source having the better vertical location uncertainty is selected, even if that source's horizontal location uncertainty is a little worse (i.e., within the threshold horizontal location uncertainty difference) than the other identified source.

Returning again to FIG. 7B, after the horizontal location data and vertical location data of the selected identified source are used as captured location data for the user device at block 718, process 700 flows to decision block 720. At decision block 720, a determination is made whether two other sources are identified and processed. As mentioned above, in some embodiments, each combination of two sources of the plurality of sources are identified and compared using process 700. If two other sources are to be identified, process 700 flows from decision block 720 to block 714; otherwise, process 700 terminates or otherwise returns to a calling process to perform other actions.

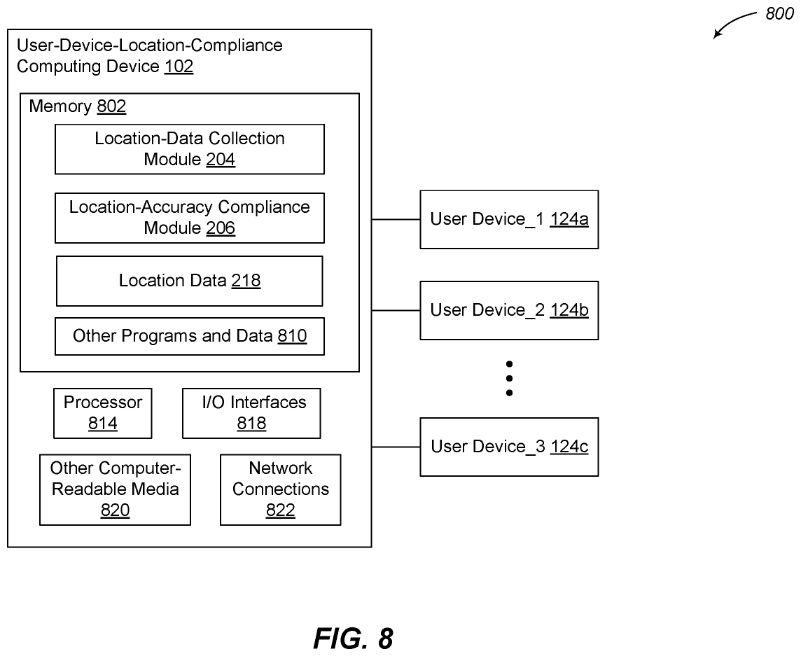

FIG. 8 shows a system diagram that describe various implementations of computing systems for implementing embodiments described herein. System 800 includes a mobile-device-location-compliance computing device 102 and user devices 124a-124c.

The mobile-device-location-compliance computing device 102 is a computing system or environment that obtains, receives, or collects location data of user device 124a-124c that is making corresponding 911 calls and selecting specific data to use as the collected location for the corresponding call, as described herein. One or more special-purpose computing systems may be used to implement the mobile-device-location-compliance computing device 102. Accordingly, various embodiments described herein may be implemented in software, hardware, firmware, or in some combination thereof. The mobile-device-location-compliance computing device 102 includes memory 802, processor 814, I/O interfaces 818, other computer-readable media 820, and network connections 822.

Processor 814 may include one or more central processing units, circuitry, or other computing components or units-collectively referred to as a processor or one or more processors—that are configured to performed embodiments herein or to execute computer instructions to perform embodiments described herein. In some embodiments, a single processor may operate individually to perform embodiments described herein. In other embodiments, a plurality of processors may operate to collectively perform embodiments described herein, such that one or more processors may operate to perform some, but not all, of the embodiments described herein.

Memory 802 may include one or more various types of non-volatile and/or volatile storage technologies. Examples of memory 802 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 802 may be utilized to store information, including computer-readable instructions that are utilized by processor 814 to perform actions, including embodiments described herein.

Memory 802 may have stored thereon location-data collection module 204 and location-accuracy compliance module 206. The location-data collection module 204 is configured to receive location data 218 from user devices 124a-124c for a plurality of calls. The location-accuracy compliance module 206 is configured to select horizontal location data and vertical location data from one or more sources as the captured location data for a corresponding user device for a corresponding call, as described herein. Memory 802 may also store location data 218 and other programs and data 410 (e.g., operating systems, other call-related data, etc.)

Network connections 822 are configured to communicate with other computing devices, such as user devices 124a-124c. In various embodiments, the network connections 822 include transmitters and receivers (not illustrated) to send and receive data as described herein. I/O interfaces 818 may include one or more data input or output interfaces, video or display interfaces, or other input/output interfaces. Other computer-readable media 820 may include other types of stationary or removable computer-readable media, such as removable flash drives, external hard drives, or the like.

The user devices 124a-124c may include computing components similar to mobile-device-location-compliance computing device 102, but are not shown in FIG. 8 for ease of discussion.

The following is a summarization of the claims as filed.

A method may be summarized as comprising: obtaining, from a plurality of sources, horizontal location data and vertical location data of a user device using a location-based service via a cellular communications network; for each corresponding source of the plurality of sources: determining a horizontal location uncertainty of the horizontal location data for the corresponding source; determining a vertical location uncertainty of the vertical location data for the corresponding source; determining if both the horizontal location uncertainty for the corresponding source meets a threshold horizontal uncertainty value and the vertical location uncertainty for the corresponding source meets a threshold vertical uncertainty value; in response to determining that both the horizontal location uncertainty for the corresponding source meets the threshold horizontal uncertainty value and the vertical location uncertainty for the corresponding source meets the threshold vertical uncertainty value, identifying the corresponding source as compliant; and in response to determining that at least one of the horizontal location uncertainty for the corresponding source fails to meet the threshold horizontal uncertainty value or the vertical location uncertainty for the corresponding source fails to meet the threshold vertical uncertainty value, identifying the corresponding source as non-compliant; and in response to identifying no compliant source: selecting a lowest horizontal location uncertainty from among the plurality of sources; selecting a lowest vertical location uncertainty from among the plurality of sources; and using the selected lowest horizontal location data and the selected lowest vertical location data as captured location data for the user device using the location-based service.

The method may further comprise: employing the selected lowest horizontal location data and the selected lowest vertical location data to determine if the cellular communications network is providing compliant location data across a plurality of uses of the location-based service.

The method may select the lowest horizontal location uncertainty from among the plurality of sources by: selecting the lowest horizontal location uncertainty from a first source that is separate from a second source from which the lowest vertical location uncertainty is selected.

The method may select the lowest vertical location uncertainty from among the plurality of sources by: selecting the lowest vertical location uncertainty from a first source that is separate from a second source from which the lowest horizontal location uncertainty is selected.

The method may further comprise: determining that the horizontal location data and the vertical location data obtained from the plurality of sources were captured for a same use of the location-based service.

In some embodiments, the user device in the method may use of the location-based service to make a 911 call.

The method may further comprise: in response to identifying at least one compliant source, selecting an optimum compliant source from the at least one compliant source.

A computing system may be summarized as comprising: a memory configured to store computer instructions; and a processor configured to execute the computer instructions to:

obtain, from a plurality of sources, horizontal location data and vertical location data of a user device using a location-based service via a cellular communications network; for each corresponding source of the plurality of sources: determine a horizontal location uncertainty of the horizontal location data for the corresponding source; determine a vertical location uncertainty of the vertical location data for the corresponding source; determine if both the horizontal location uncertainty for the corresponding source meets a threshold horizontal uncertainty value and the vertical location uncertainty for the corresponding source meets a threshold vertical uncertainty value; in response to determining that both the horizontal location uncertainty for the corresponding source meets the threshold horizontal uncertainty value and the vertical location uncertainty for the corresponding source meets the threshold vertical uncertainty value, identify the corresponding source as compliant; and in response to determining that at least one of the horizontal location uncertainty for the corresponding source fails to meet the threshold horizontal uncertainty value or the vertical location uncertainty for the corresponding source fails to meet the threshold vertical uncertainty value, identify the corresponding source as non-compliant; and in response to identifying no compliant source: select a lowest horizontal location uncertainty from among the plurality of sources; select a lowest vertical location uncertainty from among the plurality of sources; and use the selected lowest horizontal location data and the selected lowest vertical location data as captured location data for the user device using the location-based service.

The processor of the computing system may be configured to further execute the computer instructions to: employ the selected lowest horizontal location data and the selected lowest vertical location data to determine if the cellular communications network is providing compliant location data across a plurality of uses of the location-based service.

The processor of the computing system may select the lowest horizontal location uncertainty from among the plurality of sources by being configured to further execute the computer instructions to: select the lowest horizontal location uncertainty from a first source that is separate from a second source from which the lowest vertical location uncertainty is selected.

The processor of the computing system may select the lowest vertical location uncertainty from among the plurality of sources by being configured to further execute the computer instructions to: select the lowest vertical location uncertainty from a first source that is separate from a second source from which the lowest horizontal location uncertainty is selected.

The processor of the computing system may be configured to further execute the computer instructions to: determine that the horizontal location data and the vertical location data obtained from the plurality of sources were captured for a same use of the location-based service.

In some embodiments, the user device in the computing system may use the location-based service make a 911 call.

The processor of the computing system may be configured to further execute the computer instructions to: in response to identifying at least one compliant source, select an optimum compliant source from the at least one compliant source.

A non-transitory computer-readable medium may be summarized as storing computer instructions that, when executed by at least one processor, cause the at least one processor to perform actions, the actions comprising: obtaining, from a plurality of sources, horizontal location data and vertical location data of a user device using a location-based service via a cellular communications network; for each corresponding source of the plurality of sources: determining a horizontal location uncertainty of the horizontal location data for the corresponding source; determining a vertical location uncertainty of the vertical location data for the corresponding source; determining if both the horizontal location uncertainty for the corresponding source meets a threshold horizontal uncertainty value and the vertical location uncertainty for the corresponding source meets a threshold vertical uncertainty value; in response to determining that both the horizontal location uncertainty for the corresponding source meets the threshold horizontal uncertainty value and the vertical location uncertainty for the corresponding source meets the threshold vertical uncertainty value, identifying the corresponding source as compliant; and in response to determining that at least one of the horizontal location uncertainty for the corresponding source fails to meet the threshold horizontal uncertainty value or the vertical location uncertainty for the corresponding source fails to meet the threshold vertical uncertainty value, identifying the corresponding source as non-compliant; and in response to identifying no compliant source: selecting a lowest horizontal location uncertainty from among the plurality of sources; selecting a lowest vertical location uncertainty from among the plurality of sources; and using the selected lowest horizontal location data and the selected lowest vertical location data as captured location data for the user device using the location-based service.

The computer instructions stored in the non-transitory computer-readable medium, when executed by the at least one processor, may cause the at least one processor to perform further actions, the further actions comprising: employing the selected lowest horizontal location data and the selected lowest vertical location data to determine if the cellular communications network is providing compliant location data across a plurality of uses of the location-based service.

The computer instructions stored in the non-transitory computer-readable medium may select the lowest horizontal location uncertainty from among the plurality of sources by causing the at least one processor to perform further actions, the further actions comprising: selecting the lowest horizontal location uncertainty from a first source that is separate from a second source from which the lowest vertical location uncertainty is selected.

The computer instructions stored in the non-transitory computer-readable medium may select the lowest vertical location uncertainty from among the plurality of sources by causing the at least one processor to perform further actions, the further actions comprising: selecting the lowest vertical location uncertainty from a first source that is separate from a second source from which the lowest horizontal location uncertainty is selected.

The computer instructions stored in the non-transitory computer-readable medium, when executed by the at least one processor, may cause the at least one processor to perform further actions, the further actions comprising: determining that the horizontal location data and the vertical location data obtained from the plurality of sources were captured for a same use of the location-based service.

In some embodiments, the user device may use the location-based service to make a 911 call.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
obtaining, from a plurality of sources, horizontal location data and vertical location data of a user device using a location-based service via a cellular communications network;
for each corresponding source of the plurality of sources:
determining a horizontal location uncertainty of the horizontal location data for the corresponding source;
determining a vertical location uncertainty of the vertical location data for the corresponding source;
determining if both the horizontal location uncertainty for the corresponding source meets a threshold horizontal uncertainty value and the vertical location uncertainty for the corresponding source meets a threshold vertical uncertainty value;
in response to determining that both the horizontal location uncertainty for the corresponding source meets the threshold horizontal uncertainty value and the vertical location uncertainty for the corresponding source meets the threshold vertical uncertainty value, identifying the corresponding source as compliant; and
in response to determining that at least one of the horizontal location uncertainty for the corresponding source fails to meet the threshold horizontal uncertainty value or the vertical location uncertainty for the corresponding source fails to meet the threshold vertical uncertainty value, identifying the corresponding source as non-compliant; and
in response to identifying no compliant source:
selecting a lowest horizontal location uncertainty from among the plurality of sources;
selecting a lowest vertical location uncertainty from among the plurality of sources; and
using the selected lowest horizontal location data and the selected lowest vertical location data as captured location data for the user device using the location-based service.

2. The method of claim 1, further comprising:
employing the selected lowest horizontal location data and the selected lowest vertical location data to determine if the cellular communications network is providing compliant location data across a plurality of uses of the location-based service.

3. The method of claim 1, wherein selecting the lowest horizontal location uncertainty from among the plurality of sources comprises:
selecting the lowest horizontal location uncertainty from a first source that is separate from a second source from which the lowest vertical location uncertainty is selected.

4. The method of claim 1, wherein selecting the lowest vertical location uncertainty from among the plurality of sources comprises:
selecting the lowest vertical location uncertainty from a first source that is separate from a second source from which the lowest horizontal location uncertainty is selected.

5. The method of claim 1, further comprising:
determining that the horizontal location data and the vertical location data obtained from the plurality of sources were captured for a same use of the location-based service.

6. The method of claim 1, wherein the user device using the location-based service include the user device making a 911 call.

7. The method of claim 1, further comprising:
in response to identifying at least one compliant source, selecting an optimum compliant source from the at least one compliant source.

8. A computing system, comprising:
a memory configured to store computer instructions; and
a processor configured to execute the computer instructions to:
obtain, from a plurality of sources, horizontal location data and vertical location data of a user device using a location-based service via a cellular communications network;
for each corresponding source of the plurality of sources:
determine a horizontal location uncertainty of the horizontal location data for the corresponding source;
determine a vertical location uncertainty of the vertical location data for the corresponding source;
determine if both the horizontal location uncertainty for the corresponding source meets a threshold horizontal uncertainty value and the vertical location uncertainty for the corresponding source meets a threshold vertical uncertainty value;
in response to determining that both the horizontal location uncertainty for the corresponding source meets the threshold horizontal uncertainty value and the vertical location uncertainty for the corresponding source meets the threshold vertical uncertainty value, identify the corresponding source as compliant; and
in response to determining that at least one of the horizontal location uncertainty for the corresponding source fails to meet the threshold horizontal uncertainty value or the vertical location uncertainty for the corresponding source fails to meet the threshold vertical uncertainty value, identify the corresponding source as non-compliant; and
in response to identifying no compliant source:
select a lowest horizontal location uncertainty from among the plurality of sources;
select a lowest vertical location uncertainty from among the plurality of sources; and
use the selected lowest horizontal location data and the selected lowest vertical location data as captured location data for the user device using the location-based service.

9. The computing system of claim 8, wherein the processor is configured to further execute the computer instructions to:
employ the selected lowest horizontal location data and the selected lowest vertical location data to determine if the cellular communications network is providing compliant location data across a plurality of uses of the location-based service.

10. The computing system of claim 8, wherein the processor selects the lowest horizontal location uncertainty from among the plurality of sources by being configured to further execute the computer instructions to:
select the lowest horizontal location uncertainty from a first source that is separate from a second source from which the lowest vertical location uncertainty is selected.

11. The computing system of claim 8, wherein the processor selects the lowest vertical location uncertainty from among the plurality of sources by being configured to further execute the computer instructions to:
select the lowest vertical location uncertainty from a first source that is separate from a second source from which the lowest horizontal location uncertainty is selected.

12. The computing system of claim 8, wherein the processor is configured to further execute the computer instructions to:
determine that the horizontal location data and the vertical location data obtained from the plurality of sources were captured for a same use of the location-based service.

13. The computing system of claim 8, wherein the user device using the location-based service include the user device making a 911 call.

14. The computing system of claim 8, wherein the processor is configured to further execute the computer instructions to:
in response to identifying at least one compliant source, select an optimum compliant source from the at least one compliant source.

15. A non-transitory computer-readable medium storing computer instructions that, when executed by at least one processor, cause the at least one processor to perform actions, the actions comprising:
obtaining, from a plurality of sources, horizontal location data and vertical location data of a user device using a location-based service via a cellular communications network;
for each corresponding source of the plurality of sources:
determining a horizontal location uncertainty of the horizontal location data for the corresponding source;
determining a vertical location uncertainty of the vertical location data for the corresponding source;
determining if both the horizontal location uncertainty for the corresponding source meets a threshold horizontal uncertainty value and the vertical location uncertainty for the corresponding source meets a threshold vertical uncertainty value;
in response to determining that both the horizontal location uncertainty for the corresponding source meets the threshold horizontal uncertainty value and the vertical location uncertainty for the corresponding source meets the threshold vertical uncertainty value, identifying the corresponding source as compliant; and
in response to determining that at least one of the horizontal location uncertainty for the corresponding source fails to meet the threshold horizontal uncertainty value or the vertical location uncertainty for the corresponding source fails to meet the threshold vertical uncertainty value, identifying the corresponding source as non-compliant; and
in response to identifying no compliant source:
selecting a lowest horizontal location uncertainty from among the plurality of sources;
selecting a lowest vertical location uncertainty from among the plurality of sources; and
using the selected lowest horizontal location data and the selected lowest vertical location data as captured location data for the user device using the location-based service.

16. The non-transitory computer-readable medium of claim 15, wherein the computer instructions, when executed by the at least one processor, cause the at least one processor to perform further actions, the further actions comprising:
employing the selected lowest horizontal location data and the selected lowest vertical location data to determine if the cellular communications network is providing compliant location data across a plurality of uses of the location-based service.

17. The non-transitory computer-readable medium of claim 15, wherein selecting the lowest horizontal location uncertainty from among the plurality of sources comprises:
selecting the lowest horizontal location uncertainty from a first source that is separate from a second source from which the lowest vertical location uncertainty is selected.

18. The non-transitory computer-readable medium of claim 15, wherein selecting the lowest vertical location uncertainty from among the plurality of sources comprises:
selecting the lowest vertical location uncertainty from a first source that is separate from a second source from which the lowest horizontal location uncertainty is selected.

19. The non-transitory computer-readable medium of claim 15, wherein the computer instructions, when executed by the at least one processor, cause the at least one processor to perform further actions, the further actions comprising:
determining that the horizontal location data and the vertical location data obtained from the plurality of sources were captured for a same use of the location-based service.

20. The non-transitory computer-readable medium of claim 15, wherein the user device using the location-based service include the user device making a 911 call.
